(19) United States
(12) Patent Application Publication
(10) Pub. No.: US 2025/0052879 A1
(43) Pub. Date: Feb. 13, 2025

(54) WAVEFORM FOR JOINT COMMUNICATIONS AND RADIO FREQUENCY (RF) SENSING

(71) Applicant: QUALCOMM Incorporated, San Diego, CA (US)

(72) Inventors: Weimin DUAN, San Diego, CA (US); Alexandros MANOLAKOS, Athens (GR); Krishna Kiran MUKKAVILLI, San Diego, CA (US)

(21) Appl. No.: 18/718,008

(22) PCT Filed: Jan. 25, 2023
(86) PCT No.: PCT/US2023/061250

§ 371 Date: Jun. 7, 2024

(30) Foreign Application Priority Data
Feb. 24, 2022 (GR) 20220100169

(51) Int. Cl. G01S 11/02; H04L 5/00; H04W 72/0446

(52) U.S. Cl. CPC G01S 11/026; H04L 5/0007; H04L 5/0053; H04W 72/0446

(57) ABSTRACT

Disclosed are systems and techniques for efficient joint communications and radio frequency (RF) sensing. For example, a method for communications and sensing can include receiving, by a receiver, a first signal based on a reflection of a second signal from a target, wherein the first signal comprises a waveform including a plurality of communications instances and a plurality of sensing instances. The method can include determining, using radio frequency sensing, at least one characteristic of the target based on information in at least one of the plurality of sensing instances.

### CROSS-REFERENCE TO RELATED APPLICATIONS

This application for Patent is a 371 of international Patent Application PCT/US2023/061250, filed Jan. 25, 2023, which claims priority to Greek patent application No. 20220100169, filed Feb. 24, 2022, all of which are hereby incorporated by referenced in their entirety and for all purposes.

### FIELD OF THE DISCLOSURE

The present disclosure generally relates to joint communications and radio frequency (RF) sensing. For example, aspects of the disclosure relate to systems and techniques that employ waveforms (e.g., orthogonal frequency-division multiplexing (OFDM) waveforms) to provide for efficient joint communications and RF sensing.

### BACKGROUND OF THE DISCLOSURE

Wireless communications systems are widely deployed to provide various types of communication content, such as voice, video, packet data, messaging, and broadcast. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE). Some wireless communications systems may support communications between UEs, which may involve direct transmissions between two or more UEs.

Due to larger bandwidths being allocated for wireless cellular communications systems (e.g., including 5G) and more use cases being introduced into the cellular communications systems, joint communications and RF sensing on a same waveform can be an essential feature for future cellular systems because it can provide for a very high spectral efficiency design that efficiently utilizes frequency bandwidth.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems and techniques for performing joint communications and RF sensing.

According to at least one example, a method is provided for communications and sensing. The method includes: receiving, by a receiver, a first signal based on a reflection of a second signal from a target, wherein the first signal comprises a waveform including a plurality of communications instances and a plurality of sensing instances; and determining, using radio frequency sensing, at least one characteristic of the target based on information in at least one of the plurality of sensing instances.

In another example, an apparatus for communications and sensing is provided that includes a memory (e.g., configured to store data, such as virtual content data, one or more images, etc.) and one or more processors (e.g., implemented in circuitry) coupled to the memory. The one or more processors are configured to and can: receive a first signal based on a reflection of a second signal from a target, wherein the first signal comprises a waveform including a plurality of communications instances and a plurality of sensing instances; and determine, using radio frequency sensing, at least one characteristic of the target based on information in at least one of the plurality of sensing instances.

In another example, a non-transitory computer-readable medium of a receiver is provided. The non-transitory computer-readable medium has stored thereon instructions that, when executed by one or more processors, cause the one or more processors to: receive a first signal based on a reflection of a second signal from a target, wherein the first signal comprises a waveform including a plurality of communications instances and a plurality of sensing instances; and determine, using radio frequency sensing, at least one characteristic of the target based on information in at least one of the plurality of sensing instances.

In another example, an apparatus for communications and sensing is provided. The apparatus includes: means for receiving a first signal based on a reflection of a second signal from a target, wherein the first signal comprises a waveform including a plurality of communications instances and a plurality of sensing instances; and means for determining, using radio frequency sensing, at least one characteristic of the target based on information in at least one of the plurality of sensing instances.

In some aspects, wherein the at least one characteristic comprises at least one of a range, a doppler frequency, or an angle associated with the target.

In some aspects, wherein the waveform is an orthogonal frequency-division multiplexing (OFDM) waveform.

In some aspects, wherein each communications instance of the plurality of communications instances comprises a communications symbol.

In some aspects, wherein each sensing instance of the plurality of sensing instances comprises a plurality of radar reference signals.

In some aspects, wherein the at least one characteristic of the target is determined based on at least one radar reference signal of the plurality of radar reference signals.

In some aspects, wherein the plurality of radar reference signals are continuous within each sensing instance of the plurality of sensing instances.

In some aspects, wherein the plurality of radar reference signals are not continuous within each sensing instance of the plurality of sensing instances.

In some aspects, wherein each sensing instance of the plurality of sensing instances comprises a single radar reference signal.

In some aspects, wherein the radio frequency sensing is monostatic sensing, and wherein the receiver is co-located with a transmitter transmitting the second signal.

In some aspects, wherein the radio frequency sensing is bistatic sensing, and wherein the receiver is located remotely from a transmitter transmitting the second signal.

In some aspects, the apparatus is, or is part of, a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a tablet computer, an Internet-of-Things (IoT) device, a wireless access point, a vehicle or component of a vehicle, a server computer, a robotics device, or other device. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors, which can be used for determining a location of the apparatuses, a state of the apparatuses (e.g., a temperature, a humidity level, and/or other state), and/or for other purposes.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a block diagram illustrating an example of a computing system of an electronic device that may be employed by the disclosed system for joint communications and radio frequency (RF) sensing, in accordance with some examples.

FIG. 2 is a diagram illustrating an example of a wireless device utilizing RF monostatic sensing techniques, which may be employed by the disclosed system for joint communications and RF sensing, to detect a target in the form of a vehicle, in accordance with some examples.

FIG. 3 is a diagram illustrating an example of a receiver, in the form of a vehicle, utilizing RF bistatic sensing techniques, which may be employed by the disclosed system for joint communications and RF sensing, to detect a target in the form of a vehicle, in accordance with some examples.

FIG. 4 is a diagram illustrating geometry for bistatic (or monostatic) sensing, in accordance with some examples.

FIG. 5 is a diagram illustrating a bistatic range of bistatic sensing, in accordance with some examples.

FIG. 6 is a diagram showing an example of a waveform that may be employed by the disclosed system for joint communications and RF sensing, in accordance with some examples.

FIG. 7 is a diagram showing an example of a cyclic-prefix orthogonal frequency-division multiplexing (CP-OFDM) waveform, in accordance with some examples.

FIG. 8 is a diagram showing an example of an OFDM waveform including a plurality of non-continuous radar reference signals (RSs) within each RF sensing instance, that may be employed by the disclosed system for joint communications and RF sensing, in accordance with some examples.

FIG. 9 is a diagram showing another example of an OFDM waveform including a single radar reference signal (RS) within each RF sensing instance, that may be employed by the disclosed system for joint communications and RF sensing, in accordance with some examples.

FIG. 10 is a diagram showing another example of an OFDM waveform including a plurality of continuous radar RSs within each RF sensing instance, that may be employed by the disclosed system for joint communications and RF sensing, in accordance with some examples.

FIG. 11 is a flow chart showing the disclosed method for joint communications and RF sensing, in accordance with some examples.

FIG. 12 is a block diagram illustrating an example of a computing system that may be employed by the disclosed system for joint communications and RF sensing, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

The systems and techniques disclosed herein provide operative systems for efficient joint communications and RF sensing. In one or more examples, the systems and techniques of the present disclosure employs a waveform (e.g., an OFDM waveform) that includes a plurality of communications instances for communications and includes a plurality of sensing instances for RF sensing, such as monostatic sensing and/or multi-static sensing (e.g., bistatic sensing).

Radar sensing systems typically use RF waveforms to estimate the distance, angle, and/or velocity of a target, such as a vehicle, an obstruction, a user, a building, or other object. A typical radar system includes at least one transmitter, at least one receiver, and at least one processor. A radar sensing system may perform monostatic sensing when one receiver is employed that is co-located with a transmitter. A radar system may perform bistatic sensing when one receiver of a first device is employed that is located remote from a transmitter of a second device. Similarly, a radar system may perform multi-static sensing when multiple receivers of multiple devices are employed that are all located remotely from at least one transmitter of at least one device.

During operation of a radar sensing system, a transmitter transmits an electromagnetic (EM) signal in the RF domain towards a target. The signal reflects off of the target to produce one or more reflection signals, which provides information or properties regarding the target, such as target's location and speed. At least one receiver receives the one or more reflection signals and at least one processor, which may be associated with at least one receiver, utilizes the information from the one or more reflection signals to determine information or properties of the target.

It should be noted that these radar sensing signals, which can be referred to as radar reference signals (RSS), are typically designed for and solely used for sensing purposes. Radar RSs do not contain any communications information and may not support communications purposes. For example, a radar RS may not be support multi-user multiplexing, as does a demodulation reference signal (DMRS) design (e.g., a communications RS design).

Conversely, communication RSs are typically designed for and solely used for communications purposes, including estimating channel parameters for communications. Communication RSs may not support radar sensing purposes. For example, a tracking reference signal design (e.g., a communications RS design) may not need to achieve a very high accuracy Doppler estimation, as may be required by a radar RS design.

Systems, apparatuses, processes (also referred to as methods), and computer-readable media (collectively referred to herein as systems and techniques) are described herein that provide a waveform (e.g., an OFDM waveform or other waveform) that supports both communications and RF sensing. An OFDM waveform will be used herein as an illustrative example of a waveform provided by the systems and techniques. However, the systems and techniques may provide any type of waveform that supports both communications and RF sensing.

In some aspects, an OFDM waveform is formed by using a legacy OFDM waveform, such as a cyclic-prefix orthogonal frequency-division multiplexing (CP-OFDM) waveform. A CP-OFDM waveform comprises a plurality of durations. In a legacy CP-OFDM waveform, each of the durations includes a communications signal (instance) or a cyclic prefix (CP), where the communications signals and the CPs are alternating with one another within the waveform. Each communication signal (instance) includes a communications symbol, which is formed by a plurality of bits. Each CP includes an identical copy (with no new information) of the last portion of a preceding communications symbol to prevent inter-symbol interference (ISI) between successive communications symbols. The length of the durations of the CPs are frequency dependent, and can be adaptive.

The disclosed OFDM waveform utilizes the CP durations (or modified durations) of a legacy CP-OFDM waveform for the transmission of radar RSs instead of for the transmission of an identical copy of the last portion of a preceding communications symbol, as does the legacy CP-OFDM waveform. Utilizing the disclosed OFDM waveform for both communications and RF sensing provides for a very high spectral efficiency design. The duration of the OFDM waveform in which one or more radar RSs (e.g., within an RF sensing instance of the waveform) is signaled can be referred to herein as a sensing CP or sensing duration. In some aspects, the duration of the legacy CP can be utilized for a sensing CP or duration to transmit radar RSs. In other aspects, a longer or shorter duration as compared to the legacy CP can be used for a sensing CP or duration to transmit radar RSs. In such aspects, the sensing CP duration for joint communication and sensing is different than the legacy CP duration. In addition, in some examples, the sensing CP durations of the disclosed OFDM waveform can be flexibly configured in length to reduce any unnecessary transmission/reception energy (e.g., for base station and/or UE power savings). The disclosed OFDM waveform may be designed to resolve any range alias issues and to achieve symbol-level alignment for a uniform transceiver design (e.g., a uniform air interface).

Additional details regarding the disclosed systems and methods that employ the disclosed OFDM waveforms to provide for efficient joint communications and RF sensing, as well as specific implementations, are described below.

As used herein, the terms “user equipment” (UE) and “network entity” (or “network device” or “network node”) are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device.” a “wireless device.” a “subscriber device,” a “subscriber terminal,” a “subscriber station,” a “user terminal” or “UT,” a “mobile device.” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity (or network device or network node) can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity.” (or network device or network node) or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

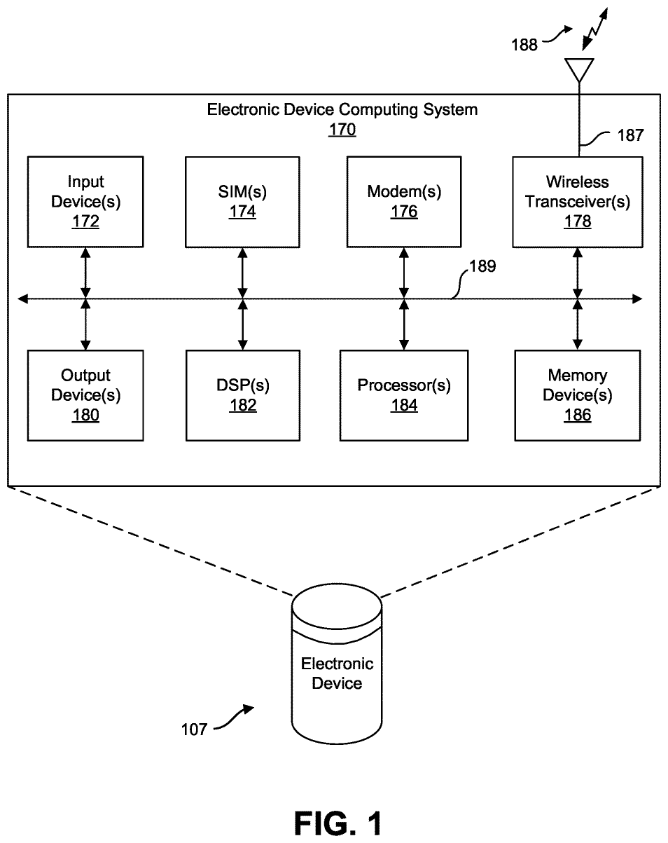

FIG. 1 is a block diagram illustrating an example of a computing system 170 of an electronic device 107 that may be employed by the disclosed system for joint communications and RF sensing, in accordance with some examples. The electronic device 107 is an example of a device that can include hardware and software for the purpose of connecting and exchanging data with other devices and systems using a communications network (e.g., a 3^{rd} Generation Partnership network, such as a 5^{th} Generation (5G)/New Radio (NR) network, a 4^{th} Generation (4G)/Long Term Evolution (LTE) network, a Wifi network, or other communications network). For example, the electronic device 107 can include, or be a part of, a mobile device (e.g., a mobile telephone), a wearable device (e.g., a network-connected or smart watch), an extended reality device (e.g., a virtual reality (VR) device, an augmented reality (AR) device, or a mixed reality (MR) device), a personal computer, a laptop computer, a tablet computer, an Internet-of-Things (IoT) device, a wireless access point, a router, a vehicle or component of a vehicle, a server computer, a robotics device, and/or other device used by a user to communicate over a wireless communications network. In some cases, the device 107 can be referred to as user equipment (UE), such as when referring to a device configured to communicate using 5G/NR, 4G/LTE, or other telecommunication standard. In some cases, the device can be referred to as a station (STA), such as when referring to a device configured to communicate using the Wi-Fi standard.

The computing system 170 includes software and hardware components that can be electrically or communicatively coupled via a bus 189 (or may otherwise be in communication, as appropriate). For example, the computing system 170 includes one or more processors 184. The one or more processors 184 can include one or more CPUs, ASICS, FPGAS, APs, GPUs, VPUs, NSPs, microcontrollers, dedicated hardware, any combination thereof, and/or other processing device/s and/or system/s. The bus 189 can be used by the one or more processors 184 to communicate between cores and/or with the one or more memory devices 186.

The computing system 170 may also include one or more memory devices 186, one or more digital signal processors (DSPs) 182, one or more subscriber identity modules (SIMs) 174, one or more modems 176, one or more wireless transceivers 178, one or more antennas 187, one or more input devices 172 (e.g., a camera, a mouse, a key board, a touch sensitive screen, a touch pad, a keypad, a microphone or a microphone array, and/or the like), and one or more output devices 180 (e.g., a display, a speaker, a printer, and/or the like).

The one or more wireless transceivers 178 can receive wireless signals (e.g., signal 188) via antenna 187 from one or more other devices, such as other user devices, network devices (e.g., base stations such as evolved Node Bs (eNBs) and/or gNodeBs (gNBs), WiFi access points (APs) such as routers, range extenders or the like, etc.), cloud networks, and/or the like. In some examples, the computing system 170 can include multiple antennas or an antenna array that can facilitate simultaneous transmit and receive functionality. Antenna 187 can be an omnidirectional antenna such that RF signals can be received from and transmitted in all directions. The wireless signal 188 may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network. In some examples, the one or more wireless transceivers 178 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals 188 into a baseband or intermediate frequency and can convert the RF signals to the digital domain.

In some cases, the computing system 170 can include a coding-decoding device (or CODEC) configured to encode and/or decode data transmitted and/or received using the one or more wireless transceivers 178. In some cases, the computing system 170 can include an encryption-decryption device or component configured to encrypt and/or decrypt data (e.g., according to the Advanced Encryption Standard (AES) and/or Data Encryption Standard (DES) standard) transmitted and/or received by the one or more wireless transceivers 178.

The one or more SIMs 174 can each securely store an international mobile subscriber identity (IMSI) number and related key assigned to the user of the electronic device 107. The IMSI and key can be used to identify and authenticate the subscriber when accessing a network provided by a network service provider or operator associated with the one or more SIMs 174. The one or more modems 176 can modulate one or more signals to encode information for transmission using the one or more wireless transceivers 178. The one or more modems 176 can also demodulate signals received by the one or more wireless transceivers 178 in order to decode the transmitted information. In some examples, the one or more modems 176 can include a WiFi modem, a 4G (or LTE) modem, a 5G (or NR) modem, and/or other types of modems. The one or more modems 176 and the one or more wireless transceivers 178 can be used for communicating data for the one or more SIMs 174.

The computing system 170 can also include (and/or be in communication with) one or more non-transitory machine-readable storage media or storage devices (e.g., one or more memory devices 186), which can include, without limitation, local and/or network accessible storage, a disk drive, a drive array, an optical storage device, a solid-state storage device such as a RAM and/or a ROM, which can be programmable, flash-updateable and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 186 and executed by the one or more processor(s) 184 and/or the one or more DSPs 182. The computing system 170 can also include software elements (e.g., located within the one or more memory devices 186), including, for example, an operating system, device drivers, executable libraries, and/or other code, such as one or more application programs, which may comprise computer programs implementing the functions provided by various aspects, and/or may be designed to implement methods and/or configure systems, as described herein.

In some aspects, the electronic device 107 can include means for performing operations described herein. The means can include one or more of the components of the computing system 170. For example, the means for performing operations described herein may include one or more of input device(s) 172, SIM(s) 174, modems(s) 176, wireless transceiver(s) 178, output device(s) 180, DSP(s) 182, processors 184, memory device(s) 186, and/or antenna(s) 187.

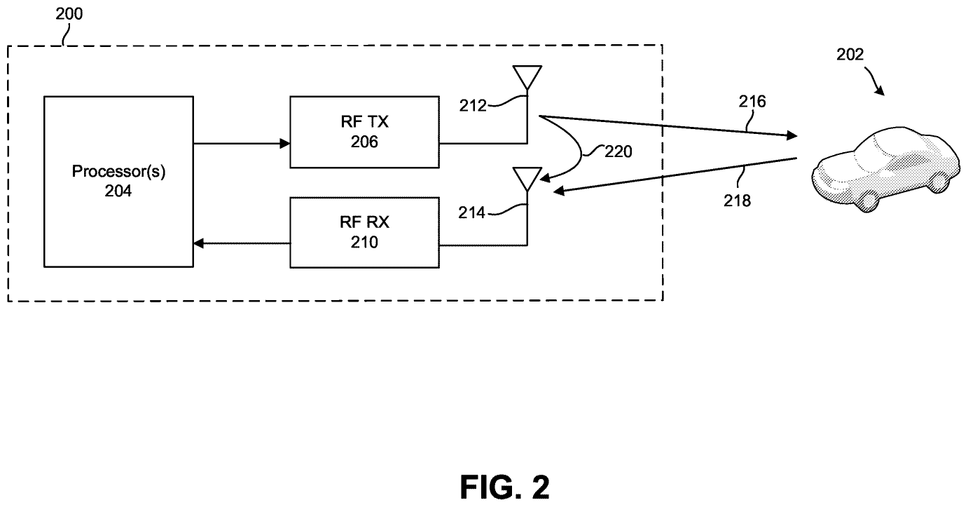

FIG. 2 is a diagram illustrating an example of a wireless device 200 utilizing RF monostatic sensing techniques, which may be employed by the disclosed system for joint communications and RF sensing, to detect a target 202 in the form of a vehicle, in accordance with some examples. In particular, FIG. 2 is a diagram illustrating an example of a wireless device 200 that utilizes RF sensing techniques (e.g., monostatic sensing) to perform one or more functions, such as detecting a presence and location of a target 202 (e.g., an object, user, or vehicle), which in this figure is illustrated in the form of a vehicle.

In some examples, the wireless device 200 can be a mobile phone, a tablet computer, a wearable device, a vehicle, an XR device, a computing device or component of a vehicle, or other device (e.g., device 107 of FIG. 1) that includes at least one RF interface. In some examples, the wireless device 200 can be a device that provides connectivity for a user device (e.g., for electronic device 107 of FIG. 1), such as a base station (e.g., a gNB, eNB, etc.), a wireless access point (AP), or other device that includes at least one RF interface.

In some aspects, wireless device 200 can include one or more components for transmitting an RF signal. The wireless device 200 can include at least one processor 204 that is capable of determining signals (e.g., determining the waveforms for the signals) to be transmitted and is capable of processing signals that are received. The signals to be transmitted are provided to an RF transmitter 206 for transmission. The RF transmitter 206 can be a Wi-Fi transmitter, a 5G/NR transmitter, a Bluetooth™ transmitter, or any other transmitter capable of transmitting an RF signal.

RF transmitter 206 can be coupled to one or more transmitting antennas such as Tx antenna 212. In some examples, transmit (Tx) antenna 212 can be an omnidirectional antenna that is capable of transmitting an RF signal in all directions. For example, Tx antenna 212 can be an omnidirectional Wi-Fi antenna that can radiate Wi-Fi signals (e.g., 2.4 GHz, 5 GHZ, 6 GHZ, etc.) in a 360-degree radiation pattern. In another example, Tx antenna 212 can be a directional antenna that transmits an RF signal in a particular direction.

In some examples, wireless device 200 can also include one or more components for receiving an RF signal. For example, the receiver lineup in wireless device 200 can include one or more receiving antennas such as a receive (Rx) antenna 214. In some examples, Rx antenna 214 can be an omnidirectional antenna capable of receiving RF signals from multiple directions. In other examples, Rx antenna 214 can be a directional antenna that is configured to receive signals from a particular direction. In further examples, both Tx antenna 212 and Rx antenna 214 can include multiple antennas (e.g., elements) configured as an antenna array.

Wireless device 200 can also include an RF receiver 210 that is coupled to Rx antenna 214. RF receiver 210 can include one or more hardware components for receiving an RF waveform such as a Wi-Fi signal, a Bluetooth™ signal, a 5G/NR signal, or any other RF signal. The output of RF receiver 210 can be coupled to at least one processor 204. The processor(s) 204 can be configured to process a received waveform (e.g., Rx waveform 218).

In one example, wireless device 200 can implement RF sensing techniques, for example monostatic sensing techniques, by causing a Tx waveform 216 to be transmitted from Tx antenna 212. Although Tx waveform 216 is illustrated as a single line, in some cases, Tx waveform 216 can be transmitted in all directions by an omnidirectional Tx antenna 212. In one example, Tx waveform 216 can be a Wi-Fi waveform that is transmitted by a Wi-Fi transmitter in wireless device 200. In some cases, Tx waveform 216 can correspond to a Wi-Fi waveform that is transmitted at or near the same time as a Wi-Fi data communication signal or a Wi-Fi control function signal (e.g., a beacon transmission). In some examples, Tx waveform 216 can be transmitted using the same or a similar frequency resource as a Wi-Fi data communication signal or a Wi-Fi control function signal (e.g., a beacon transmission). In some aspects, Tx waveform 216 can correspond to a Wi-Fi waveform that is transmitted separately from a Wi-Fi data communication signal and/or a Wi-Fi control signal (e.g., Tx waveform 216 can be transmitted at different times and/or using a different frequency resource).

In some examples, Tx waveform 216 can correspond to a 5G NR waveform that is transmitted at or near the same time as a 5G NR data communication signal or a 5G NR control function signal. In some examples, Tx waveform 216 can be transmitted using the same or a similar frequency resource as a 5G NR data communication signal or a 5G NR control function signal. In some aspects, Tx waveform 216 can correspond to a 5G NR waveform that is transmitted separately from a 5G NR data communication signal and/or a 5G NR control signal (e.g., Tx waveform 216 can be transmitted at different times and/or using a different frequency resource).

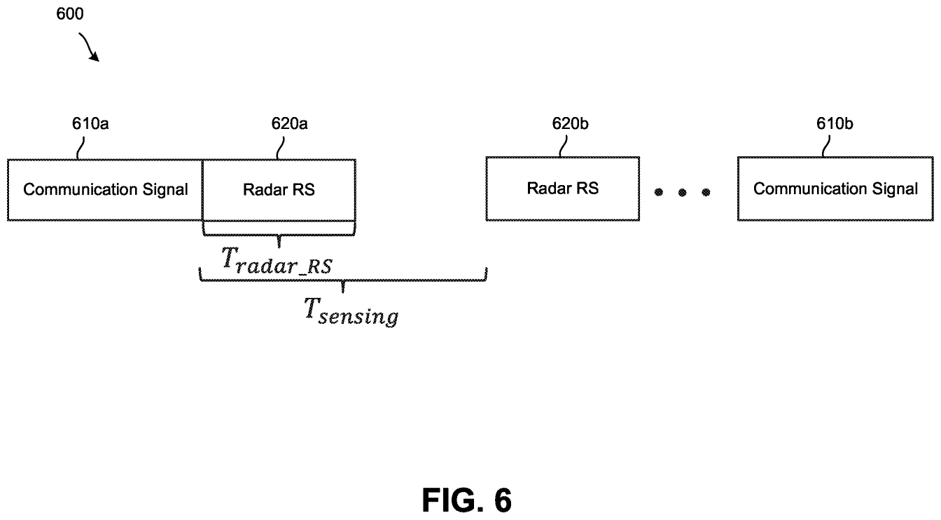

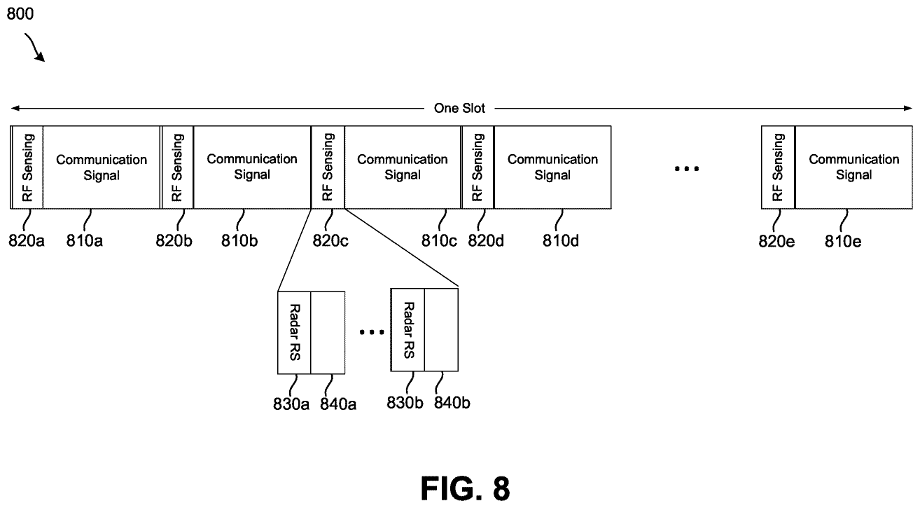

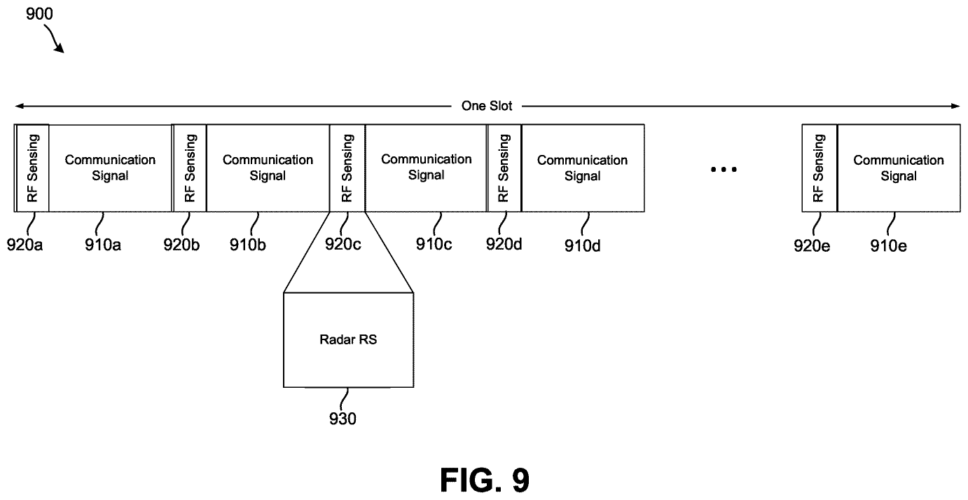

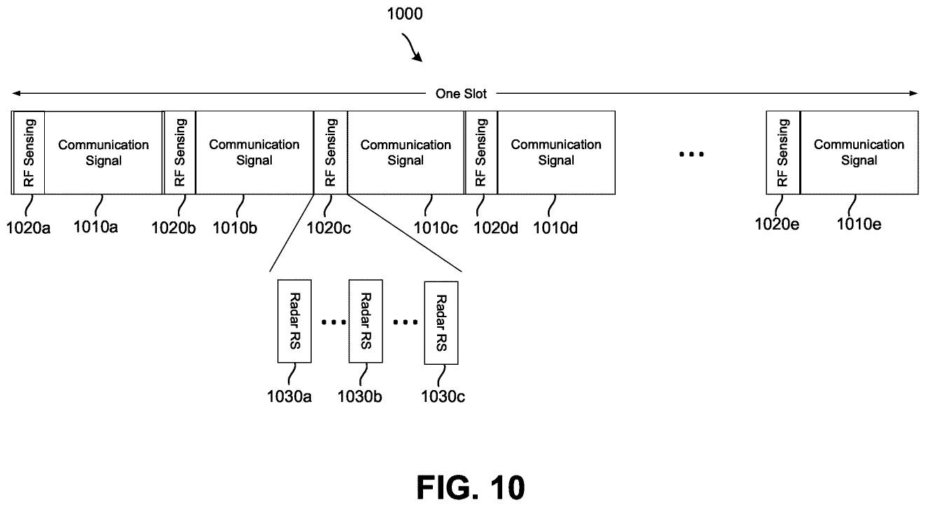

In some aspects, one or more parameters associated with Tx waveform 216 can be modified that may be used to increase or decrease RF sensing resolution. The parameters may include frequency, bandwidth, number of spatial streams, the number of antennas configured to transmit Tx waveform 216, the number of antennas configured to receive a reflected RF signal (e.g., Rx waveform 218) corresponding to Tx waveform 216, the number of spatial links (e.g., number of spatial streams multiplied by number of antennas configured to receive an RF signal), the sampling rate, or any combination thereof. The transmitted waveform (e.g., Tx waveform 216) and the received waveform (e.g., the Rx waveform 218) can include one or more radar RSs (also referred to as RF sensing RSs). In some examples, the Tx waveform 216 and/or the Rx waveform 218 may comprise one of the waveforms disclosed herein (e.g., waveform 600 of FIG. 6, OFDM waveform 800 of FIG. 8, OFDM waveform 900 of FIG. 9, or OFDM waveform 1000 of FIG. 10).

In some aspects, wireless device 200 can implement RF sensing techniques by performing alternating transmit and receive functions (e.g., performing a half-duplex operation). For example, wireless device 200 can alternately enable its RF transmitter 206 to transmit the Tx waveform 216 when the RF receiver 210 is not enabled to receive (i.e. not receiving), and enable its RF receiver 210 to receive the Rx waveform 218 when the RF transmitter 206 is not enabled to transmit (i.e. not transmitting). When the wireless device 200 is performing a half-duplex operation, the wireless device 200 may transmit an OFDM waveform, such as disclosed OFDM waveform 800 of FIG. 8 or other waveform described herein, which contains non-continuous radar RSs.

In other aspects, wireless device 200 can implement RF sensing techniques by performing concurrent transmit and receive functions (e.g., performing a full-duplex operation). For example, wireless device 200 can enable its RF receiver 210 to receive at or near the same time as it enables RF transmitter 206 to transmit Tx waveform 216. When the wireless device 200 is performing a full-duplex operation, the wireless device 200 may transmit an OFDM waveform, such as OFDM waveform 800 of FIG. 8, OFDM waveform 900 of FIG. 9, or OFDM waveform 1000 of FIG. 10.

In some examples, transmission of a sequence or pattern that is included in Tx waveform 216 can be repeated continuously such that the sequence is transmitted a certain number of times or for a certain duration of time. In some examples, repeating a pattern in the transmission of Tx waveform 216 can be used to avoid missing the reception of any reflected signals if RF receiver 210 is enabled after RF transmitter 206. In one example implementation, Tx waveform 216 can include a sequence having a sequence length L (e.g., a length of one slot of a waveform) that is transmitted two or more times, which can allow RF receiver 210 to be enabled at a time less than or equal to L in order to receive reflections corresponding to the entire sequence without missing any information.

By implementing alternating or simultaneous transmit and receive functionality (e.g. half-duplex or full-duplex operation), wireless device 200 can receive signals that correspond to Tx waveform 216. For example, wireless device 200 can receive signals that are reflected from objects or people that are within range of Tx waveform 216, such as Rx waveform 218 reflected from target 202. Wireless device 200 can also receive leakage signals (e.g., Tx leakage signal 220) that are coupled directly from Tx antenna 212 to Rx antenna 214 without reflecting from any objects. For example, leakage signals can include signals that are transferred from a transmitter antenna (e.g., Tx antenna 212) on a wireless device to a receive antenna (e.g., Rx antenna 214) on the wireless device without reflecting from any objects. In some cases, Rx waveform 218 can include multiple sequences that correspond to multiple copies of a sequence that are included in Tx waveform 216. In some examples, wireless device 200 can combine the multiple sequences that are received by RF receiver 210 to improve the signal to noise ratio (SNR).

Wireless device 200 can further implement RF sensing techniques by obtaining RF sensing data associated with each of the received signals corresponding to Tx waveform 216. In some examples, the RF sensing data can include channel state information (CSI) data relating to the direct paths (e.g., leakage signal 220) of Tx waveform 216 together with data relating to the reflected paths (e.g., Rx waveform 218) that correspond to Tx waveform 216.

In some aspects, RF sensing data (e.g., CSI data) can include information that can be used to determine the manner in which an RF signal (e.g., Tx waveform 216) propagates from RF transmitter 206 to RF receiver 210. RF sensing data can include data that corresponds to the effects on the transmitted RF signal due to scattering, fading, and/or power decay with distance, or any combination thereof. In some examples, RF sensing data can include imaginary data and real data (e.g., I/Q components) corresponding to each tone in the frequency domain over a particular bandwidth.

In some examples, RF sensing data can be used by the processor(s) 204 to calculate distances and angles of arrival that correspond to reflected waveforms, such as Rx waveform 218. In further examples, RF sensing data can also be used to detect motion, determine location, detect changes in location or motion patterns, or any combination thereof. In some cases, the distance and angle of arrival of the reflected signals can be used to identify the size, position, movement, and/or orientation of targets (e.g., target 202) in the surrounding environment in order to detect target presence/proximity.

The processor(s) 204 of the wireless device 200 can calculate distances and angles of arrival corresponding to reflected waveforms (e.g., the distance and angle of arrival corresponding to Rx waveform 218) by utilizing signal processing, machine learning algorithms, any other suitable technique, or any combination thereof. In other examples, wireless device 200 can transmit or send the RF sensing data to at least one processor of another computing device, such as a server, that can perform the calculations to obtain the distance and angle of arrival corresponding to Rx waveform 218 or other reflected waveforms.

In one example, the distance of Rx waveform 218 can be calculated by measuring the difference in time from reception of the leakage signal to the reception of the reflected signals. For example, wireless device 200 can determine a baseline distance of zero that is based on the difference from the time the wireless device 200 transmits Tx waveform 216 to the time it receives leakage signal 220 (e.g., propagation delay). The processor(s) 204 of the wireless device 200 can then determine a distance associated with Rx waveform 218 based on the difference from the time the wireless device 200 transmits Tx waveform 216 to the time it receives Rx waveform 218 (e.g., time of flight), which can then be adjusted according to the propagation delay associated with leakage signal 220. In doing so, the processor(s) 204 of the wireless device 200 can determine the distance traveled by Rx waveform 218 which can be used to determine the presence and movement of a target (e.g., target 202) that caused the reflection.

In further examples, the angle of arrival of Rx waveform 218 can be calculated by the processor(s) 204 by measuring the time difference of arrival of Rx waveform 218 between individual elements of a receive antenna array, such as antenna 214. In some examples, the time difference of arrival can be calculated by measuring the difference in received phase at each element in the receive antenna array.

In some cases, the distance and the angle of arrival of Rx waveform 218 can be used by processor(s) 204 to determine the distance between wireless device 200 and target 202 as well as the position of the target 202 relative to the wireless device 200. The distance and the angle of arrival of Rx waveform 218 can also be used to determine presence, movement, proximity, identity, or any combination thereof, of target 202. For example, the processor(s) 204 of the wireless device 200 can utilize the calculated distance and angle of arrival corresponding to Rx waveform 218 to determine that the target 202 is moving towards wireless device 200.

As noted above, wireless device 200 can include mobile devices (e.g., IoT devices, smartphones, laptops, tablets, etc.) or other types of devices. In some examples, wireless device 200 can be configured to obtain device location data and device orientation data together with the RF sensing data. In some instances, device location data and device orientation data can be used to determine or adjust the distance and angle of arrival of a reflected signal such as Rx waveform 218. For example, wireless device 200 may be set on a table facing the sky as a target 202 moves towards it during the RF sensing process. In this instance, wireless device 200 can use its location data and orientation data together with the RF sensing data to determine the direction that the target 202 is moving.

In some examples, device position data can be gathered by wireless device 200 using techniques that include round trip time (RTT) measurements, passive positioning, angle of arrival (AoA), received signal strength indicator (RSSI), CSI data, using any other suitable technique, or any combination thereof. In further examples, device orientation data can be obtained from electronic sensors on the wireless device 200, such as a gyroscope, an accelerometer, a compass, a magnetometer, a barometer, any other suitable sensor, or any combination thereof.

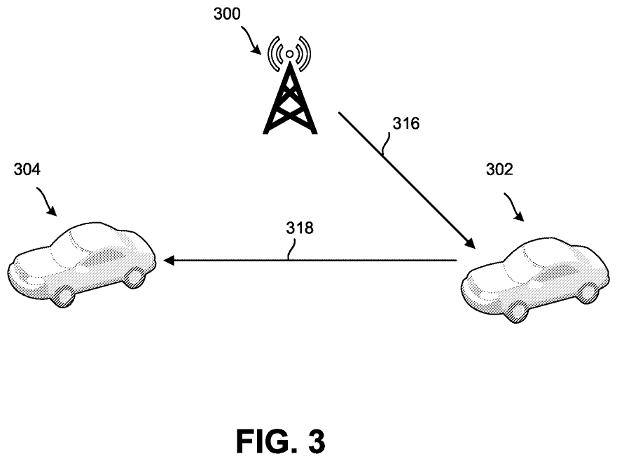

FIG. 3 is a diagram illustrating an example of a receiver 304, in the form of a vehicle, utilizing RF bistatic sensing techniques, which may be employed by the disclosed system for joint communications and RF sensing, to perform one or more functions. For example, the receiver 304 can use the RF bistatic sensing to detect a presence and location of a target 302 (e.g., an object, user, or vehicle), which is illustrated in the form of a vehicle in FIG. 3.

The bistatic radar system of FIG. 3 includes a transmitter 300 (e.g., which in this figure is depicted to be in the form of a base station) and a receiver 304 that are separated by a distance comparable to the expected target distance. As compared to the monostatic system of FIG. 2, the transmitter 300 and the receiver 304 of the bistatic radar system of FIG. 3 are located remote from one another. Conversely, monostatic radar is a radar system (e.g., the system of FIG. 2) comprising a transmitter (e.g., the RF transmitter 206 of wireless device 200 of FIG. 2) and a receiver (e.g., the RF receiver 210 of wireless device 200 of FIG. 2) that are co-located with one another.

An advantage of bistatic radar (or more generally, multistatic radar, which has more than one receiver) over monostatic radar is the ability to collect radar returns reflected from a scene at angles different than that of a transmitted pulse. This can be of interest to some applications (e.g., vehicle applications, scenes with multiple objects, military applications, etc.) where targets may reflect the transmitted energy in many directions (e.g., where targets are specifically designed to reflect in many directions), which can minimize the energy that is reflected back to the transmitter. It should be noted that, in one or more examples, a monostatic system can coexist with a multistatic radar system, such as when the transmitter also has a co-located receiver.

In some examples, the transmitter 300 and/or the receiver 304 of FIG. 3 can be a mobile phone, a tablet computer, a wearable device, a vehicle, or other device (e.g., device 107 of FIG. 1) that includes at least one RF interface. In some examples, the transmitter 300 and/or the receiver 304 can be a device that provides connectivity for a user device (e.g., for IoT device 107 of FIG. 1), such as a base station (e.g., a gNB, eNB, etc.), a wireless access point (AP), or other device that includes at least one RF interface.

In some aspects, transmitter 300 can include one or more components for transmitting an RF signal. The transmitter 300 can include at least one processor (e.g., the at least one processor 204 of FIG. 2) that is capable of determining signals (e.g., determining the waveforms for the signals) to be transmitted. The transmitter 300 can also include an RF transmitter (e.g., the RF transmitter 206 of FIG. 2) for transmission of a Tx signal comprising Tx waveform 316. The RF transmitter can be a transmitter configured to transmit cellular or telecommunication signals (e.g., a transmitter configured to transmit 5G/NR signals, 4G/LTE signals, or other cellular/telecommunication signals, etc.), a Wi-Fi transmitter, a Bluetooth™ transmitter, any combination thereof, or any other transmitter capable of transmitting an RF signal.

The RF transmitter can be coupled to one or more transmitting antennas, such as a Tx antenna (e.g., to the TX antenna 212 of FIG. 2). In some examples, a Tx antenna can be an omnidirectional antenna that is capable of transmitting an RF signal in all directions, or a directional antenna that transmits an RF signal in a particular direction. In some examples, the Tx antenna may include multiple antennas (e.g., elements) configured as an antenna array.

The receiver 304 can include one or more components for receiving an RF signal. For example, the receiver 304 may include one or more receiving antennas, such as an Rx antenna (e.g., to the Rx antenna 214 of FIG. 2). In some examples, an Rx antenna can be an omnidirectional antenna capable of receiving RF signals from multiple directions, or a directional antenna that is configured to receive signals from a particular direction. In further examples, the Rx antenna can include multiple antennas (e.g., elements) configured as an antenna array.

The receiver 304 may also include an RF receiver (e.g., RF receiver 210 of FIG. 2) coupled to the Rx antenna. The RF receiver may include one or more hardware components for receiving an RF waveform such as a Wi-Fi signal, a Bluetooth™ signal, a 5G/NR signal, or any other RF signal. The output of the RF receiver can be coupled to at least one processor (e.g., the at least one processor 204 of FIG. 2). The processor(s) may be configured to process a received waveform (e.g., Rx waveform 318).

In one or more examples, transmitter 300 can implement RF sensing techniques, for example bistatic sensing techniques, by causing a Tx waveform 316 to be transmitted from a Tx antenna. It should be noted that although the Tx waveform 316 is illustrated as a single line, in some cases, the Tx waveform 316 can be transmitted in all directions by an omnidirectional Tx antenna.

In one or more aspects, one or more parameters associated with the Tx waveform 316 may be used to increase or decrease RF sensing resolution. The parameters may include frequency, bandwidth, number of spatial streams, the number of antennas configured to transmit Tx waveform 316, the number of antennas configured to receive a reflected RF signal (e.g., Rx waveform 318) corresponding to the Tx waveform 316, the number of spatial links (e.g., number of spatial streams multiplied by number of antennas configured to receive an RF signal), the sampling rate, or any combination thereof. The transmitted waveform (e.g., Tx waveform 316) and the received waveform (e.g., the Rx waveform 318) can include one or more radar RSs (also referred to as RF sensing RSs). In one or more examples, the Tx waveform 316 and/or the Rx waveform 318 may comprise one of the waveforms disclosed herein (e.g., waveform 600 of FIG. 6, OFDM waveform 800 of FIG. 8, OFDM waveform 900 of FIG. 9, or OFDM waveform 1000 of FIG. 10).

During operation, the receiver 304 can receive signals that correspond to Tx waveform 216. For example, the receiver 304 can receive signals that are reflected from objects or people that are within range of the Tx waveform 316, such as Rx waveform 318 reflected from target 302. In some cases, the Rx waveform 318 can include multiple sequences that correspond to multiple copies of a sequence that are included in the Tx waveform 316. In some examples, the receiver 304 may combine the multiple sequences that are received to improve the signal to noise ratio (SNR).

In some examples, RF sensing data can be used by at least one processor within the receiver 304 to calculate distances, angles of arrival, or other characteristics that correspond to reflected waveforms, such as the Rx waveform 318. In other examples, RF sensing data can also be used to detect motion, determine location, detect changes in location or motion patterns, or any combination thereof. In some cases, the distance and angle of arrival of the reflected signals can be used to identify the size, position, movement, and/or orientation of targets (e.g., target 302) in the surrounding environment in order to detect target presence/proximity.

The processor(s) of the receiver 304 can calculate distances and angles of arrival corresponding to reflected waveforms (e.g., the distance and angle of arrival corresponding to the Rx waveform 318) by using signal processing, machine learning algorithms, any other suitable technique, or any combination thereof. In other examples, the receiver 304 can transmit or send the RF sensing data to at least one processor of another computing device, such as a server, that can perform the calculations to obtain the distance and angle of arrival corresponding to the Rx waveform 318 or other reflected waveforms.

In one or more examples, the angle of arrival of the Rx waveform 318 can be calculated by a processor(s) of the receiver 304 by measuring the time difference of arrival of the Rx waveform 318 between individual elements of a receive antenna array of the receiver 304. In some examples, the time difference of arrival can be calculated by measuring the difference in received phase at each element in the receive antenna array.

In some cases, the distance and the angle of arrival of the Rx waveform 318 can be used by the processor(s) of the receiver 304 to determine the distance between the receiver 304 and the target 302 as well as the position of target 302 relative to the receiver 304. The distance and the angle of arrival of the Rx waveform 318 can also be used to determine presence, movement, proximity, identity, or any combination thereof, of the target 302. For example, the processor(s) of the receiver 304 may use the calculated distance and angle of arrival corresponding to the Rx waveform 318 to determine that the target 302 is moving towards the receiver 304.

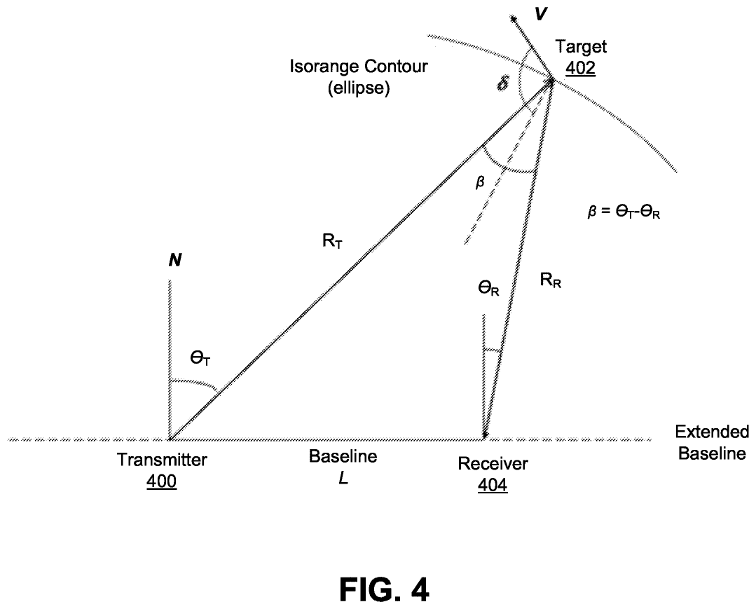

FIG. 4 is a diagram illustrating an example of a geometry for bistatic (or monostatic) sensing, in accordance with some examples. As shown in FIG. 4, a transmitter 400, a target 402, and a receiver 404 of a radar system are shown in relation to one another. The transmitter 400 and the receiver 404 are separated by a baseline distance L, the target 402 and the transmitter 400 are separated by a distance RT, and the target 402 and the receiver 404 are separated by a distance RR.

In the geometry of FIG. 4, a bistatic angle (β) is the angle subtended between the transmitter 400, the target 402, and the receiver 404 in the radar. When the bistatic angle is exactly zero (0)), the radar is considered to be a monostatic radar: when the bistatic angle is close to zero, the radar is considered to be pseudo-monostatic; and when the bistatic angle is close to 180 degrees, the radar is considered to be a forward scatter radar. Otherwise, the radar is simply considered to be, and referred to as, a bistatic radar. The bistatic angle (β) can be used in determining the radar cross section of the target.

During operation, to build up a discernible echo, most radar systems emit pulses continuously. The repetition rate of these pulses is determined by the role of the system. Different sensing schemes (e.g., monostatic sensing and bistatic sensing) have different requirements on the period of the radar reference signal (RS) transmission, which can be denoted as T_{sensing} (e.g., as shown in the waveform 600 of FIG. 6 described below).

For monostatic sensing (e.g., when the bistatic angle is equal to zero), the data period of the waveform can be denoted as T_{sensing} (e.g., as shown in the waveform 600 of FIG. 6). When performing monostatic sensing, a radar system can determine

$${T}_{sensing} \geq \frac{2 {R}_{max}}{c} + {T}_{radar \_ RS}$$

to remove the range ambiguity (e.g., to avoid an alias issue), where Rₘₐₓ is the maximum sensing range, T_{radar_RS} is the duration of the radar RS (e.g., refer to radar RS 620a and radar RS 620b of FIG. 6), and c is equal to the speed of light. If the radar RS repetition frequency is too high (e.g., the radar RS period is too small), echo signals (e.g., reflection signals) from some targets might arrive after the second radar RS (e.g., radar RS 620b of FIG. 6 is an example of a second radar RS, while radar RS 620a of FIG. 6 is an example of a first radar RS) is transmitted, which results in an ambiguity in the range measurement. Such an echo would appear to be at a much shorter range than the actual range of the target. It should be noted that typically, the receiver may assume that the echo is from the second radar RS, not the first radar RS.

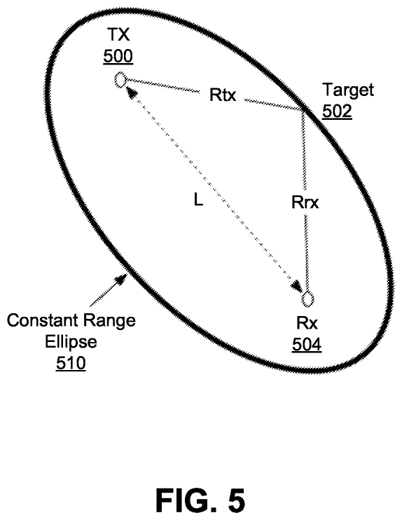

For bistatic sensing, the data period (e.g., refer to the waveform 600 of FIG. 6) of the waveform is also T_{sensing}. The minimum radar RS period in the bistatic configuration is different than in the monostatic case. To have an unambiguous solution, the leading and trailing edge of the radar RS from the transmitter-to-target-to-receiver will follow an elliptical shape (e.g., refer to ellipse 510 of FIG. 5).

The leading edge of the radar RS can be determined as: R_{T}+R_{R}=L+c T_{sensing}. The trailing edge of the radar RS can be determined as: R_{T}+R_{R}=L+c(T_{sensing}-T_{radar_RS})

For bistatic sensing, a radar system can determine

$${T}_{sensing} \geq \frac{\sqrt{{L}^{2} + 4 {R}_{T} {R}_{R}} - L}{c} + {T}_{radar \_ RS}$$

to remove the range ambiguity (e.g., to avoid an alias issue). Note that a condition may include that the surface of the maximum bistatic range is smaller than the bistatic surface of the trailing edge of the radar RS. The above-noted equation for T_{sensing} in the bistatic scenario may also work for monostatic sensing to remove range ambiguity, when L is set equal to zero.

FIG. 5 is a diagram illustrating an example of a bistatic range 510 of bistatic sensing, in accordance with some examples. In this figure, a transmitter (Tx) 500, a target 502, and a receiver (Rx) 504 of a radar are shown in relation to one another. The transmitter 500 and the receiver 504 are separated by a baseline distance L, the target 502 and the transmitter 500 are separated by a distance Rtx, and the target 502 and the receiver 504 are separated by a distance Rrx.

Bistatic range 510 (shown as an ellipse) refers to the measurement range made by radar with a separate transmitter 500 and receiver 504 (e.g., the transmitter 500 and the receiver 504 are located remote from one another). The receiver 504 measures the time difference of arrival from when the signal is transmitted by the transmitter 500 to when the signal is received by the receiver 504 from the transmitter 500 via the target 502. The bistatic range 510 defines an ellipse of constant bistatic range, referred to an iso-range contour, on which the target 502 lies, with foci centered on the transmitter 500 and the receiver 504. If the target 502 is at range Rrx from the receiver 504 and range Rtx from the transmitter 500, and the receiver 504 and the transmitter 500 are located a distance L apart from one another, then the bistatic range is equal to Rrx+Rtx−L. It should be noted that motion of the target 502 causes a rate of change of bistatic range, which results in bistatic Doppler shift.

Generally, constant bistatic range points draw an ellipsoid, with the transmitter 500 and the receiver 504 positions as the focal points. The bistatic iso-range contours are where the ground slices the ellipsoid. When the ground is flat, this intercept forms an ellipse (e.g., bistatic range 510). Note that except when the two platforms have equal altitude, these ellipses are not centered on a specular point.

FIG. 6 is a diagram showing an example of a waveform 600 that may be employed by the disclosed system for joint communications and RF sensing, in accordance with some examples. In this figure, the waveform 600 comprises a plurality of communications instances (communications signals) 610a, 610b and a plurality of radar reference signals (RSS) 620a, 620b, where the communications instances 610a, 610b and radar RSs 620a, 620b are alternating with one another. Each communication instance 610a, 610b includes a communications symbol (e.g., one OFDM symbol), which is formed by a plurality of bits.

Each radar RS 620a, 620b comprises an RF sensing signal for RF sensing (e.g., monostatic sensing or bistatic sensing). The length (duration) of a single radar RS is T_{radar_RS}, and the period of the radar RS transmission is T_{sensing}. It should be noted that this waveform 600 is compatible with a receiver performing a full-duplex operation.

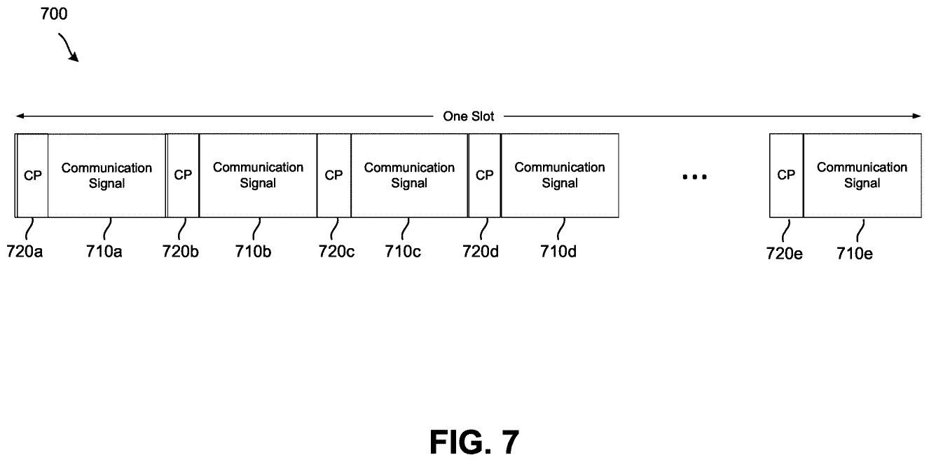

FIG. 7 is a diagram showing an example of a cyclic-prefix orthogonal frequency-division multiplexing (CP-OFDM) waveform 700. The CP-OFDM waveform 700 of FIG. 7 is a specific version of an OFDM waveform that can be utilized for a downlink signal in a telecommunication or cellular system, such as a 5G NR and/or LTE communications system. The waveform 700 is shown to include a plurality of communications instances (communications signals) 710a, 710b, 710c, 710d, 710e, and a plurality of CPs 720a, 720b, 720c, 720d, 720e. Each communications instance 710a, 710b, 710c, 710d, 710e comprises a communications symbol (e.g., one OFDM symbol), which is formed by a plurality of bits.

The CPs 720a, 720b, 720c, 720d, 720e are used to prevent inter-symbol interference (ISI) when the waveform 700 is transmitted in a dispersive channel. Each CP 720a, 720b, 720c, 720d, 720e is essentially an identical copy (with no new information) of the last portion of a preceding communications symbol of a communications instance “710a, 710b, 710c, 710d, 710e” appended before the next communications symbol of a communications instance 710a, 710b, 710c, 710d, 710e. For example, CP 720b, which precedes communications instance 710b, may include essentially an identical copy of the last portion of the communications symbol of communications instance 710a. The CPs 720a, 720b, 720c, 720d, 720e preserve the orthogonality of the subcarriers and prevent ISI between successive communications symbols of the communication instances 710a, 710b, 710c, 710d, 710e).

The length of the duration of the CPs 720a, 720b, 720c, 720d, 720e is chosen to be greater than the channel delay spread, which is frequency dependent, to overcome inter-symbol interference that can result from delays and reflections. As such, the length of the duration of the CPs 720a, 720b, 720c, 720d, 720e can be adaptive according to the link conditions.

FIG. 8 is a diagram showing an example of an OFDM waveform 800 according to the systems and techniques described herein. As shown, the OFDM waveform 800 includes a number of communications instances 810a, 810b, 810c, 810d, 810e and a number of non-continuous radar RSs 830a, 830b within a number of RF sensing instances 820a, 820b, 820c, 820d, 820e, that may be employed by the disclosed system for joint communications and RF sensing, in accordance with some examples. The OFDM waveform 800 can provide for joint communications and RF sensing. For the disclosed OFDM waveform 800, a specific transmission time interval (TTI) (e.g., a slot) is defined, where the TTI can serve both communications and RF sensing.

In some cases, each of the communications instances 810a, 810b, 810c, 810d, 810e of the OFDM waveform 800 includes a communications symbol (e.g., an OFDM symbol) formed by a plurality of bits. Each symbol can include data that can be used by a receiver of the waveform 800, such as for communications purposes (e.g., for operating a software application, for conducting a telephone call, to browse the Internet, etc.).

The duration of the OFDM waveform in which an RF sensing instance (including one or more RF RSs) is signaled can be referred to herein as a sensing duration (or sensing CP). As described in more detail herein, the sensing duration of each of the RF sensing instances 820a through 820e can correspond to a legacy CP duration or to a modified CP duration that is different from the duration of existing CPs (e.g., as defined by one or more 3GPP technical specifications (TSs)). In some aspects, the duration of a legacy CP (e.g., CP 720a of FIG. 7) can be used for an RF sensing instance (e.g., RF sensing instance 802a) to transmit RF sensing data (e.g. one or more radar RSs or RF sensing RSs). In such aspects, the OFDM waveform 800 can be formed by using a legacy CP-OFDM waveform (e.g., such as waveform 700 of FIG. 7). As described above, the legacy CP-OFDM waveform comprises a plurality of durations, which includes alternating communications instances (e.g., refer to 710a, 710b, 710c, 710d, 710e of FIG. 7) and CPs (e.g., refer to 720a, 720b, 720c, 720d, 720e of FIG. 7). In one example of using the legacy CP-OFDM waveform for joint communications and RF sensing, RF sensing data transmitted in an RF sensing instance (e.g., RF sensing instance 802a) can be transmitted during a legacy CP duration (e.g., during a duration corresponding to CP 720a of FIG. 7).

In some aspects, a longer or shorter duration as compared to a legacy CP duration can be used for an RF sensing instance to transmit RF sensing data. In such aspects, the duration of an RF sensing instance for joint communication and sensing is different than the legacy CP duration.

The waveform 800 utilizes the sensing duration (e.g., of the CPs, such as the CPs 720a, 720b, 720c, 720d, 720e of the legacy CP-OFDM waveform 700 of FIG. 7) of the sensing instances 820a, 820b, 820c, 820d, 820e for the transmission of radar RSs 830a, 830b, instead of for the transmission of an identical copy of the last portion of a preceding communications symbol, as does the legacy CP-OFDM waveform (e.g., refer to 700 of FIG. 7). The sensing duration of the sensing instances 820a, 820b, 820c, 820d, 820e of the waveform 800 can be flexibly configured in length (e.g., to be longer or shorter in length of time) to reduce any unnecessary transmission/reception energy (e.g., for base station and/or UE power savings). In the example of FIG. 8, the entire sensing duration of the sensing instances 820a, 820b, 820c, 820d, 820e is utilized for the radar RS 830a, 830b transmission and for receiving/measurement. For instance, each of the sensing instances 820a, 820b, 820c, 820d, 820e of the OFDM waveform 800 includes a plurality of radar RSs 830a, 830b and a plurality of non-transmission durations 840a, 840b (e.g., corresponding to durations of non-transmission of any radar RSs 830a, 830b), where the radar RSs 830a, 830b and the non-transmission durations 840a, 840b are alternating. In such a configuration, the radar RSs 830a, 830b are noncontinuous (not continuous) within each of the sensing instances 820a, 820b, 820c, 820d, 820e. The alternating nature of the radar RSs 830a, 830b and the non-transmission durations 840a, 840b allow the OFDM waveform 800 to be used for half-duplex operations (e.g., for monostatic sensing where the receiver and transmitter are part of the same device). As described in more detail below; the configuration of the OFDM waveform 800 can be used for bistatic sensing by devices configured to operate using half-duplex or full-duplex operations, since the transmitter and receiver are located on different devices.

As noted above, the OFDM waveform 800 can be employed by an electronic device (e.g., electronic device 107) for bistatic sensing, monostatic sensing, or both. For monostatic sensing, the OFDM waveform 800 can be used for short-range sensing (e.g., tens of meters in distance for sensing, for cellular communications systems), such as short-range monostatic sensing (e.g., UE based RF sensing). Since Rₘₐₓ could be small in short-range sensing, short-range sensing is easier to meet the condition of

$${T}_{sensing} \geq \frac{2 {R}_{max}}{c} + {T}_{radar \_ RS} .$$

Hence, the duration of the CPs (e.g., refer to 720a, 720b, 720c, 720d, 720e of FIG. 7) of the legacy CP-OFDM waveform (refer to 700 of FIG. 7) can be used for short-range monostatic sensing. In general, the duration of the RSs 830a, 830b is a trade-off between coverage and self-interference level. However, for short-range sensing, the ultra-short pulse RSs 830a, 830b should be sufficient, similar to ultra-wide band (UWB).

For traditional radar, for monostatic sensing with half-duplex operation, while the transmitter (e.g., refer to RF transmitter 206 of wireless device 200 of FIG. 2) is active (e.g., enabled), the receiver (e.g., refer to RF receiver 210 of wireless device 200 of FIG. 2) input is blanked to avoid an amplifier within the receiver line from being swamped (e.g., saturated) or damaged. As such, an ultra-short radar RS 830a, 830b can be a better option for short-range sensing, given the coverage may not be the limitation. In one or more examples, the pulse repetition of the radar RSs 830a, 830b can be used to enhance the sensing performance.

In particular, for monostatic sensing with half-duplex operation of a transmitter and receiver, during the durations of the sensing instances 820a, 820b, 820c, 820d, 820e that include the radar RSs 830a, 830b, the transmitter is enabled (e.g., refer to RF transmitter 206 of wireless device 200 of FIG. 2) to transmit the radar RSs 830a, 830b, and the receiver (e.g., refer to RF receiver 210 of wireless device 200 of FIG. 2) is not enabled to receive. During the non-transmission durations 840a, 840b of the waveform 800, the receiver is enabled to receive echos (e.g., reflection signals) produced from the radar RSs 830a, 830b reflecting off of a target (e.g., refer to target 202 of FIG. 2), and the transmitter is not enabled to transmit.

It should be noted that some hardware (HW) solutions may allow for monostatic sensing with full-duplex operation, where the transmitter and receiver are both enabled at the same time during the durations of the radar RSs 830a, 830b. For monostatic sensing with full-duplex operation of a transmitter and receiver, during the durations of the radar RSs 830a, 830b of the waveform 800, the transmitter is enabled (e.g., refer to RF transmitter 206 of wireless device 200 of FIG. 2) to transmit the radar RSs 830a, 830b, and the receiver (e.g., refer to RF receiver 210 of wireless device 200 of FIG. 2) is enabled to receive the echos (e.g., reflection signals) produced from the radar RSs 830a, 830b reflecting off of a target (e.g., refer to target 202 of FIG. 2). During the non-transmission durations 840a, 840b of the waveform 800, the transmitter is not enabled to transmit, but the receiver is still enabled to receive the echos. As such, for monostatic sensing with full-duplex operation of a transmitter and receiver, the transmitter is only enabled to transmit during the durations of the radar RSs 830a, 830b, however the receiver is enabled to receive the echos during the durations of the radar RSs 830a, 830b and during the non-transmission durations 840a, 840b.

Full-duplex operation of the transmitter and receiver can enable a longer radar RS 830a, 830b pulse to enhance the coverage. In at least one example, a sensing node (e.g., wireless device 200 of FIG. 2) could report/suggest the Rₘₐₓ to the network (or g Node B (gNB)) to guide the resource allocation of the radar RS 830a, 830b of the waveform 800.

It should be noted that to build up a discernable echo, the radar RS 830a, 830b repetition of the waveform 800 can also be applied for bistatic sensing (e.g., refer to FIGS. 3 and 4). For bistatic sensing, the radar RS 830a, 830b period configuration does not only depend on the target range (e.g., distance between the target and the transmitter), but also on the distance between the transmitter (e.g., transmitter 300 of FIG. 3 or transmitter 400 of FIG. 4) and the receiver (e.g., receiver 304 of FIG. 3 or receiver 404 of FIG. 4), such that

$${T}_{sensing} \geq \frac{\sqrt{{L}^{2} + 4 {R}_{T} {R}_{R}} - L}{c} + {T}_{radar \_ RS} .$$

For short-range bistatic sensing, the repetition of the multiple radar RS 830a, 830b in each duration of the sensing instances 820a, 820b, 820c, 820d, 820e can be configured within the durations of the legacy CPs (e.g., the CPs 720a, 720b, 720c, 720d, 720e of FIG. 7) of the legacy CP-OFDM waveform (the waveform 700 of FIG. 7), as noted above.

For wide-area bistatic sensing, the duration of the CPs (e.g., the CPs 720a, 720b, 720c, 720d, 720e of FIG. 7) of the legacy CP-OFDM waveform (the waveform 700 of FIG. 7) may not be long enough to have the repetition of the radar RS 830a, 830b repetitioning the sensing instances 820a, 820b, 820c, 820d, 820e of waveform 800, as it may cause a range ambiguity.

Various options may be employed to achieve wide-area bistatic sensing. A first option is to use a longer sensing duration (as compared to the duration of a legacy CP) for the sensing instances 820a, 820b, 820c, 820d, 820e to transmit multiple radar RSs 830a, 830b. According to the first option, a device can transmit more instances (with higher repetition) of radar RSs in each sensing instance 820a, 820b, 820c, 820d, 820e.

A second option is to transmit a single radar RS within each of the sensing instances (e.g., without any non-transmission durations), such as shown in the waveform 900 of FIG. 9. FIG. 9 is a diagram showing an example of an OFDM waveform 900 that can be employed by a computing device for joint communications and RF sensing, in accordance with some examples. The OFDM waveform 900 includes a single radar RS 930 within each RF sensing instance 920a, 920b, 920c, 920d, 920e. As described previously with respect to FIG. 8, each RF sensing instance 920a, 920b, 920c, 920d, 920e can have a sensing duration equal to a legacy CP duration or a different duration as compared to the legacy CP duration. The waveform 900 also includes a plurality of communications instances 910a, 910b, 910c, 910d, 910e, which each contain a communications symbol (e.g., an OFDM symbol) formed from a plurality of bits.

The OFDM waveform 900 is suitable for bistatic sensing as well as monostatic sensing with full-duplex operation of a transmitter and receiver. For example, because there are no non-transmission durations (e.g., like the non-transmission durations 840a, 840b of the waveform 800 of FIG. 8), the waveform 900 can be used for full-duplex operations where a device can perform data transmission and reception operations simultaneously. The waveform 900 can lead to improved bistatic RF sensing (e.g., wide area bistatic sensing), such as by reducing or eliminating range ambiguity.

A third option is to repeatably transmit a plurality of radar RSs within each of the sensing instances without any non-transmission durations, such as shown in the waveform 1000 of FIG. 10. FIG. 10 is a diagram illustrating an example of an OFDM waveform 1000 that can be employed by a computing device for joint communications and RF sensing, in accordance with some examples. The OFDM waveform 1000 includes a plurality of continuous radar RSs 1030a, 1030b, 1030c within each RF sensing instance 1020a, 1020b, 1020c, 1020d, 1020e. As described above with respect to FIG. 8, each RF sensing instance 1020a, 1020b, 1020c, 1020d, 1020e can have a sensing duration equal to a legacy CP duration or a different duration as compared to the legacy CP duration. The waveform 1000 also includes a plurality of communications instances 1010a, 1010b, 1010c, 1010d, 1010e, which each contain a communications symbol (e.g., an OFDM symbol) formed from a plurality of bits.

The OFDM waveform 1000 is also suitable for bistatic sensing as well as monostatic sensing with half-duplex or full-duplex operation (e.g., when performing short-range or wide-area RF sensing) of a transmitter and receiver. In one example, performing short-range transmissions (e.g., for short-range bistatic RF sensing) can greatly reduce power. The use of many radar RSs within an RF sensing instance can increase the effective power of the radar RSs, which can help to recover the power loss due to short-range communications.

It should be noted that with the waveforms 800, 900, and 1000 of FIGS. 8, 9, and 10, the content of the legacy CP durations is simply repeated, which can minimize the impact on the legacy device (e.g., minimize the hardware change needed within a UE). In addition, the waveforms 800, 900, and 1000 of FIGS. 8, 9, and 10 may be sequence based waveforms, such as a pseudo-random noise (PN) sequence or some classic radar waveform, such as a frequency-modulated carrier wave (FMCW). In some aspects, one or more of the radar RSs described herein can be different across different symbols.

The waveform selection (e.g., selection of the waveforms 800, 900, and 1000 of FIGS. 8, 9, and 10) may depend upon the use case, as previously discussed (e.g., short-range sensing verses wide-area sensing). In one or more examples, the receiver (e.g., a UE) may report its preference of the type of waveform (e.g., waveform 800, 900, or 1000 of FIGS. 8, 9, and 10), or indicate whether the sensing is short-range sensing or wide-area sensing, which can aid the scheduling of the type of waveform by the network and/or gNB. In addition, the radar receiver (e.g., a UE) may report the large-scale properties, such as the maximum delay, to the network and/or gNB for the waveform scheduling, especially when the system is operating in frequency division duplex (FDD) bands.

The indication of the configuration of the sensing instances (and thus the radar RSs transmitted within the sensing instances) of the various waveforms described herein (e.g., the sensing instances 820a, 820b, 820c, 820d, 820e and corresponding radar RSs 830a, 830b of the waveform 800 of FIG. 8) can be signed by a network entity, such as a base station (e.g., gNB, eNB, etc.), a location server (e.g., a location management function (LMF), a roadside unit (RSU), or other network entity. For instance, the configuration can be signaled through layer 1 (L1) signaling (e.g., downlink control information (DCI), layer 2 (L2) signaling (e.g., medium access control-control element (MAC-CE)), and/or layer 3 (L3) signaling (e.g., radio resource control (RRC)) messages. In one illustrative example, a base station (e.g., agNB, eNB, etc.) can signal the configuration of the sensing instances 820a through 820e to a UE (e.g., the electronic device 107) or other device through L1, L2, or L3 signaling.

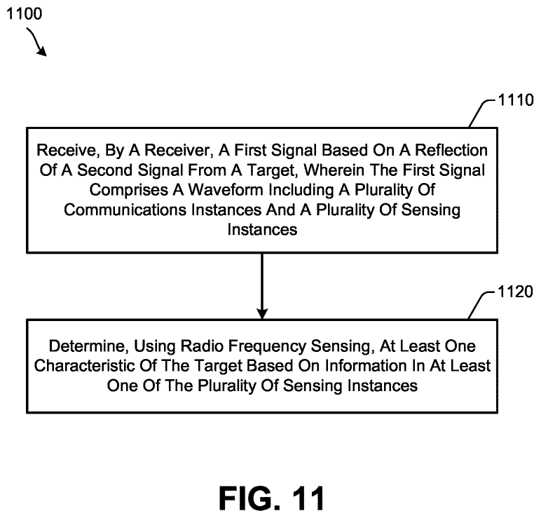

FIG. 11 is a flow chart illustrating an example of a process 1100 for joint communications and RF sensing, in accordance with some examples. The process 1100 can be performed by a computing device or apparatus, such as a wireless communications device (e.g., a UE) or a component or system (e.g., a chipset) of the wireless communication device, or a network entity (e.g., an eNB, a gNB, a location server such as an LMF) or a portion of the network entity (e.g., a chipset or one or more of a CU, a DU, a RU, a Near-RT RIC, or a Non-RT RIC). The operations of the process 1100 may be implemented as software components that are executed and run on one or more processors of the computing device (e.g., processor(s) 184 of FIG. 1, processor 204 of FIG. 2, controller/processor 1340, controller/processor 1380, and/or other processor(s)). Further, the transmission and reception of signals by the computing device in the process 1100 may be enabled, for example, by one or more antennas (e.g., antenna 187 of FIG. 1, antenna 212 and/or antenna 214 of FIG. 2, antennas 1334a through 1334t or antennas 1352a through 1352r of FIG. 13, and/or other antenna(s)), and/or one or more transceivers (e.g., wireless transceiver(s) 178 of FIG. 1, one or more of the TX MIMO processor 1366, DEMODs 1354a through 1354r, TX MIMO processor 1330, or MODs 1332a through 1332t of FIG. 13, and/or other transceivers or transceiver components).

At block 1102 of process 1100, the computing device may receive, using a receiver, a first signal based on a reflection of a second signal from a target. The first signal includes a waveform including a plurality of communications instances and a plurality of sensing instances, such as shown in the illustrative examples of FIG. 8, FIG. 9, and/or FIG. 10. In some aspects, the waveform is an orthogonal frequency-division multiplexing (OFDM) waveform. In some cases, each communications instance of the plurality of communications instances includes a communications symbol.

At block 1104 of process 1100, the computing device may determine, using radio frequency sensing, at least one characteristic of the target based on information in at least one of the plurality of sensing instances. In some examples, the at least one characteristic includes a range, a doppler frequency, an angle associated with the target, any combination thereof, and/or other characteristic(s). In some aspects, the radio frequency sensing is monostatic sensing. In such aspects, the receiver is co-located with a transmitter transmitting the second signal (e.g., as shown in FIG. 2). In some aspects, the radio frequency sensing is bistatic sensing. In such aspects, the receiver is located remotely from a transmitter transmitting the second signal (e.g., as shown in FIG. 3).

In some aspects, each sensing instance of the plurality of sensing instances includes a plurality of radar reference signals. In some examples, the at least one characteristic of the target is determined based on at least one radar reference signal of the plurality of radar reference signals. In some cases, the plurality of radar reference signals are continuous within each sensing instance of the plurality of sensing instances (e.g., as shown in FIG. 10). In some cases, the plurality of radar reference signals are not continuous within each sensing instance of the plurality of sensing instances (e.g., as shown in FIG. 8). In some examples, each sensing instance of the plurality of sensing instances includes a single radar reference signal (e.g., as shown in FIG. 9).

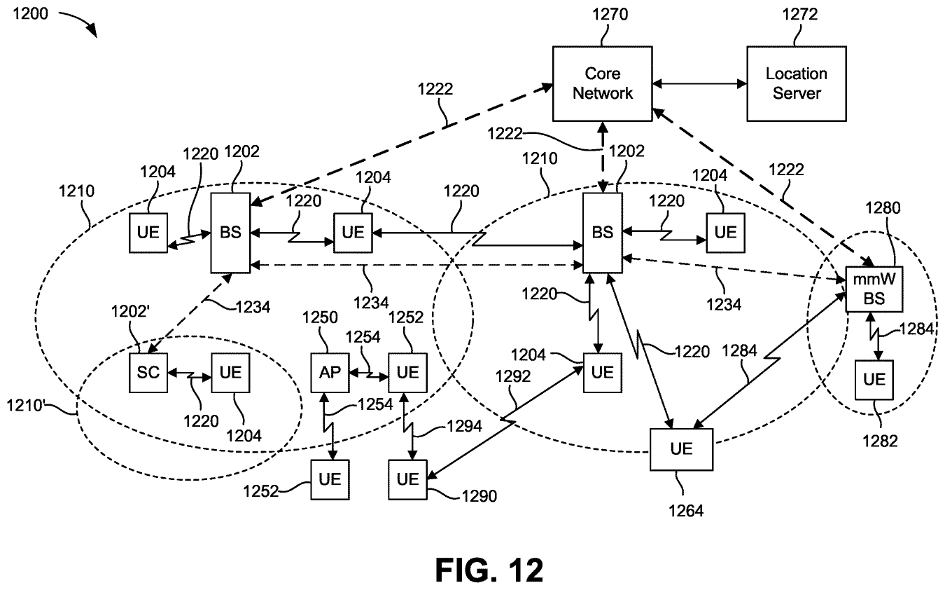

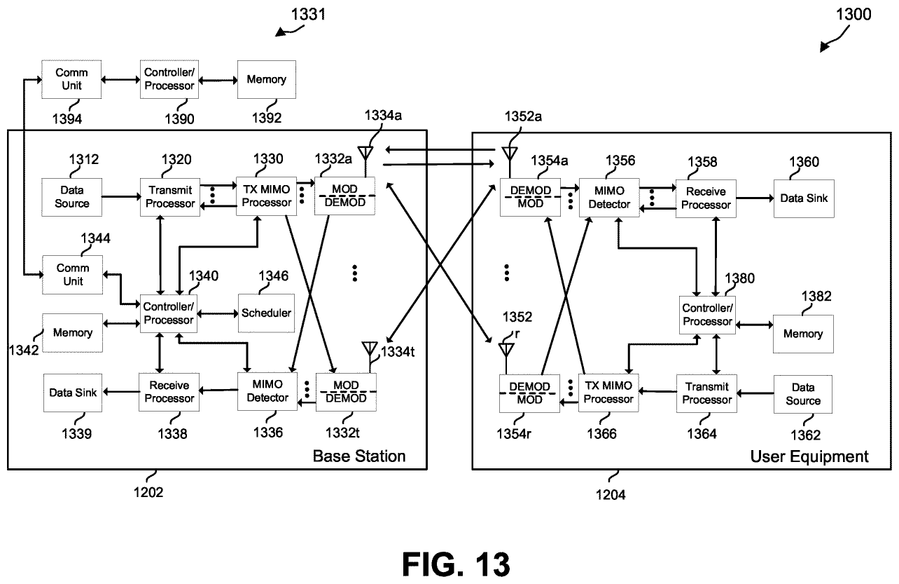

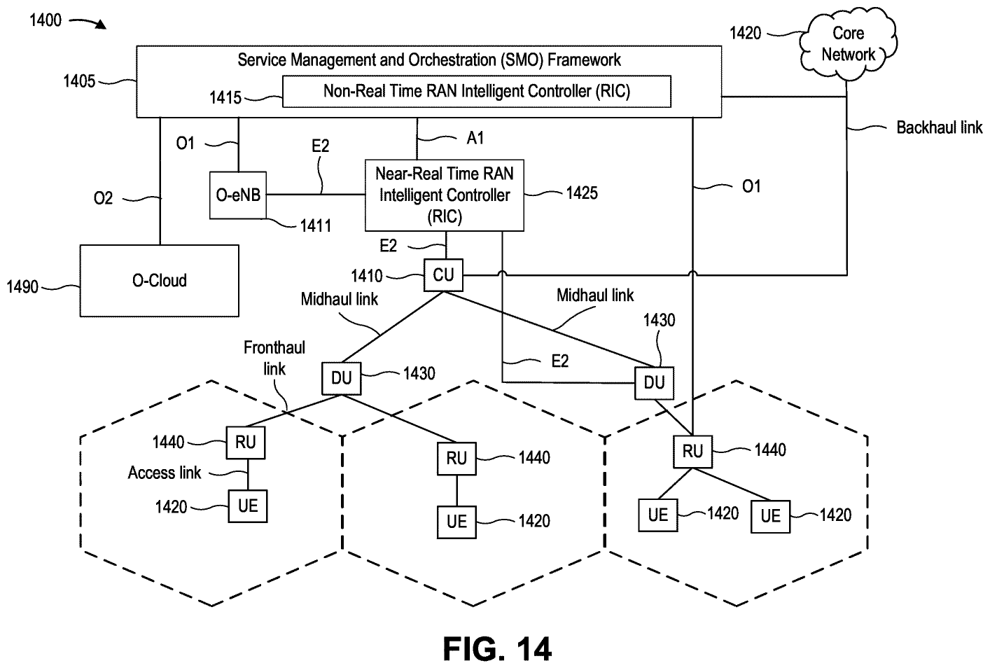

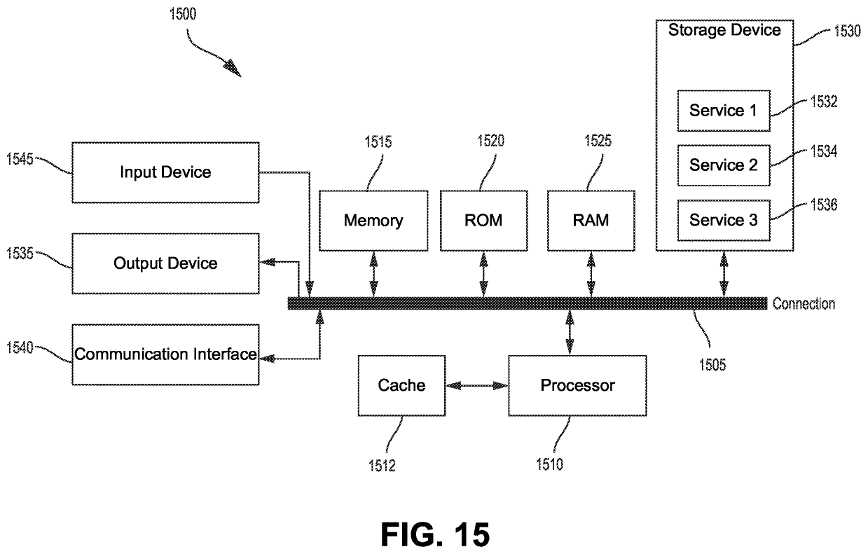

FIG. 12 illustrates an example of a wireless communications system 1200 that may be employed by the disclosed systems and techniques for a phase continuity configuration in CLI-based sensing, according to various aspects. The wireless communications system 1200 (which may also be referred to as a wireless wide area network (WWAN)) may include various base stations 1202 and various user equipment devices (UEs) 1204. As used herein, the term “UE” may be referred to interchangeably as an “access terminal” or “AT,” a “user device,” a “user terminal” or UT, a “client device,” a “wireless device,” a “subscriber device,” a “subscriber terminal,” a “subscriber station,” a “mobile device,” a “mobile terminal,” a “mobile station,” or variations thereof.

The base stations 1202 may include macro cell base stations (high power cellular base stations) and/or small cell base stations (low power cellular base stations). In an aspect, the macro cell base station may include eNBs and/or ng-eNBs where the wireless communications system 1200 corresponds to a 4G/LTE network, or gNBs where the wireless communications system 1200 corresponds to a 5G/NR network, or a combination of both, and the small cell base stations may include femtocells, picocells, microcells, etc.

The base stations 1202 may collectively form a RAN and interface with a core network 1270 (e.g., an evolved packet core (EPC) or a 5G core (5GC)) through backhaul links 1222, and through the core network 1270 to one or more location servers 1272 (which may be part of core network 1270 or may be external to core network 1270). In addition to other functions, the base stations 1202 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 1202 may communicate with each other directly or indirectly (e.g., through the EPC/5GC) over backhaul links 1234, which may be wired and/or wireless.

The base stations 1202 may wirelessly communicate with the UEs 1204. Each of the base stations 1202 may provide communication coverage for a respective geographic coverage area 1210. In an aspect, one or more cells may be supported by a base station 1202 in each coverage area 1210. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrow band IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 1210.

While neighboring macro cell base station 1202 geographic coverage areas 1210 may partially overlap (e.g., in a handover region), some of the geographic coverage areas 1210 may be substantially overlapped by a larger geographic coverage area 1210. For example, a small cell base station 1202′ may have a coverage area 1210′ that substantially overlaps with the coverage area 1210 of one or more macro cell base stations 1202. A network that includes both small cell and macro cell base stations may be known as a heterogeneous network. A heterogeneous network may also include home eNBs (HeNBs), which may provide service to a restricted group known as a closed subscriber group (CSG).

The communication links 1220 (e.g., access links) between the base stations 1202 and the UEs 1204 may include uplink (also referred to as reverse link) transmissions from a UE 1204 to a base station 1202 and/or downlink (also referred to as forward link) transmissions from a base station 1202 to a UE 1204. The communication links 1220 may use MIMO antenna technology, including spatial multiplexing, beamforming, and/or transmit diversity. The communication links 1220 may be through one or more carrier frequencies. Allocation of carriers may be asymmetric with respect to downlink and uplink (e.g., more or less carriers may be allocated for downlink than for uplink).

The wireless communications system 1200 may further include a wireless local area network (WLAN) access point (AP) 1250 in communication with WLAN stations (STAs) 1252 via communication links 1254 in an unlicensed frequency spectrum (e.g., 5 GHz). When communicating in an unlicensed frequency spectrum, the WLAN STAS 1252 and/or the WLAN AP 1250 may perform a clear channel assessment (CCA) or listen before talk (LBT) procedure prior to communicating in order to determine whether the channel is available. In some examples, the wireless communications system 1200 can include devices (e.g., UEs etc.) that communicate with one or more UEs 1204, base stations 1202, APs 1250, etc. utilizing the ultra-wideband (UWB) spectrum. The UWB spectrum can range from 3.1 to 10.5 GHZ.

The small cell base station 1202′ may operate in a licensed and/or an unlicensed frequency spectrum (e.g., utilizing LTE or NR technology and use the same 5 GHZ unlicensed frequency spectrum as used by the WLAN AP 1250). The wireless communications system 1200 may further include a millimeter wave (mmW) base station 1280 that may operate in mmW frequencies and/or near mmW frequencies in communication with a UE 1282. In some cases, mmW frequencies can be referred to as the FR2 band (e.g., including a frequency range of 24250 MHz to 52600 MHZ). In some examples, the wireless communications system 1200 can include one or more base stations (referred to herein as “hybrid base stations”) that operate in both the mmW frequencies (and/or near mmW frequencies) and in sub-6 GHz frequencies (referred to as the FR1 band, e.g., including a frequency range of 450 to 6000 MHz). In some examples, the mmW base station 1280, one or more hybrid base stations (not shown), and the UE 1282 may utilize beamforming (transmit and/or receive) over a mmW communication link 1284 to compensate for the extremely high path loss and short range. The wireless communications system 1200 may further include a UE 1264 that may communicate with a macro cell base station 1202 over a communication link 1220 and/or the mmW base station 1280 over a mmW communication link 1284.

In some examples, in order to operate on multiple carrier frequencies, a base station 1202 and/or a UE 1204 may be equipped with multiple receivers and/or transmitters. For example, a UE 1204 may have two receivers, “Receiver 1” and “Receiver 2,” where “Receiver 1” is a multi-band receiver that can be tuned to band (i.e., carrier frequency) ‘X’ or band ‘Y,’ and “Receiver 2” is a one-band receiver tuneable to band ‘Z’ only.

The wireless communications system 1200 may further include one or more UEs, such as UE 1290, that connect indirectly to one or more communication networks via one or more relay devices (e.g., UEs) by using device-to-device (D2D) peer-to-peer (P2P) links (referred to as “sidelinks”). In the example of FIG. 12, UE 1290 has a D2D P2P link 1292 with one of the UEs 1204, which can be configured to operate as a relay device (e.g., through which UE 1290 may indirectly communicate with base station 1202). In another example, UE 1290 also has a D2D P2P link 1294 with WLAN STA 1252, which is connected to the WLAN AP 1250 and can be configured to operate as a relay device (e.g., UE 1290 may indirectly communicate with AP 1250). In an example, the D2D P2P links 1292 and 1294 may be supported with any well-known D2D RAT, such as LTE Direct (LTE-D), Wi-Fi Direct (Wi-Fi-D), Bluetooth®, UWB, and so on.

As noted above, UE 1204 and UE 1290 can be configured to communicate using sidelink communications. In some examples, UE 1204 and UE 1290 can operate using one or more different modes for sidelink communications. For example, in mode 1 the cellular network (e.g., base station 1202) can select and manage the radio resources used by the UEs for performing sidelink communications. In another example, the UE 1204 and UE 1290 can be configured to operate using mode 2 in which the UEs can autonomously select the radio resources for sidelink communications. Mode 2 can operate without cellular coverage, and in some cases can be considered a baseline sidelink communications mode as devices and/or applications may not depend on the availability of cellular coverage. In some examples, mode 2 can include a distributed scheduling scheme for UEs to select radio resources.

In some aspects, UE 1204 and UE 1290 can be configured to implement a multi-beam unicast link for sidelink communications. In some examples, UE 1204 and UE 1290 can use PC5 radio resource control (RRC) protocol to establish and maintain a multi-beam unicast link that can be used for sidelink communications. In some cases, a sidelink transmission can include a request for feedback (e.g., a hybrid automatic repeat request (HARQ)) from the receiving UE. In some instances, the feedback request can be included in the sidelink control information (SCI) (e.g., SCI 1 in Physical Sidelink Control Channel (PSCCH) and/or SCI 2 in Physical Sidelink Shared Channel (PSSCH)). In some aspects, the feedback can correspond to an acknowledgement (ACK) or a negative acknowledgement (NACK).

In some examples, a transmitting UE (e.g., UE 1204 and/or UE 1290) can use feedback information to select and/or perform beam maintenance of beam pairs associated with a unicast link for sidelink communications. For example, a transmitting UE can maintain one or more counters associated with one or more beam pairs and/or one or more component beams. In some aspects, the counters can be used to determine the reliability of a component beam and/or a beam pair. In some cases, a transmitting UE may increment a counter for a beam pair and/or a component beam based on a discontinuous transmission (DTX). For example, a transmitting UE may increment a counter for a component beam and/or a beam pair if it does not receive any response to a request for feedback for an associated sidelink transmission (e.g., receiving UE fails to decode SCI). In another example, a transmitting UE may increment a counter for a component beam and/or a beam pair if it receives a NACK in response to a sidelink transmission.

In some cases, a transmitting UE may initiate beam refinement based on a value of a counter corresponding to a number of DTXs associated with a component beam and/or a beam pair. In some aspects, a transmitting UE may initiate beam recovery based on a value of a counter corresponding to a number of DTXs associated with a component beam and/or a beam pair. In some examples, a transmitting UE may detect radio link failure (RLF) based on a value of a counter corresponding to a number of DTXs associated with a component beam and/or a beam pair.

FIG. 13 shows a block diagram of a design of a base station 1202 and a UE 1204 that enable transmission and processing of signals exchanged between the UE and the base station, which may be employed by the disclosed systems and techniques for a phase continuity configuration in CLI-based sensing, in accordance with some aspects of the present disclosure. Design 1300 includes components of a base station 1202 and a UE 1204, which may be one of the base stations 1202 and one of the UEs 1204 in FIG. 12. Base station 1202 may be equipped with T antennas 1334a through 1334t, and UE 1204 may be equipped with R antennas 1352a through 1352r, where in general T≥1 and R≥1.

At base station 1202, a transmit processor 1320) may receive data from a data source 1312 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 1320 may also process system information (e.g., for semi-static resource partitioning information (SRPI) and/or the like) and control information (e.g., CQI requests, grants, upper layer signaling, and/or the like) and provide overhead symbols and control symbols. Transmit processor 1320 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 1330 may perform spatial processing (e.g., precoding) on the data symbols, the control symbols, the overhead symbols, and/or the reference symbols, if applicable, and may provide T output symbol streams to T modulators (MODs) 1332a through 1332t. The modulators 1332a through 1332t are shown as a combined modulator-demodulator (MOD-DEMOD). In some cases, the modulators and demodulators can be separate components. Each modulator of the modulators 1332a to 1332t may process a respective output symbol stream, e.g., for an orthogonal frequency-division multiplexing (OFDM) scheme and/or the like, to obtain an output sample stream. Each modulator of the modulators 1332a to 1332t may further process (e.g., convert to analog, amplify, filter, and upconvert) the output sample stream to obtain a downlink signal. T downlink signals may be transmitted from modulators 1332a to 1332t via T antennas 1334a through 1334t, respectively. According to certain aspects described in more detail below, the synchronization signals can be generated with location encoding to convey additional information.

At UE 1204, antennas 1352a through 1352r may receive the downlink signals from base station 1202 and/or other base stations and may provide received signals to demodulators (DEMODs) 1354a through 1354r, respectively. The demodulators 1354a through 1354r are shown as a combined modulator-demodulator (MOD-DEMOD). In some cases, the modulators and demodulators can be separate components. Each demodulator of the demodulators 1354a through 1354r may condition (e.g., filter, amplify, downconvert, and digitize) a received signal to obtain input samples. Each demodulator of the demodulators 1354a through 1354r may further process the input samples (e.g., for OFDM and/or the like) to obtain received symbols. A MIMO detector 1356 may obtain received symbols all R from demodulators 1354a through 1354r, perform MIMO detection on the received symbols if applicable, and provide detected symbols. A receive processor 1358 may process (e.g., demodulate and decode) the detected symbols, provide decoded data for UE 1204 to a data sink 1360, and provide decoded control information and system information to a controller/processor 1380. A channel processor may determine reference signal received power (RSRP), received signal strength indicator (RSSI), reference signal received quality (RSRQ), channel quality indicator (CQI), and/or the like.

On the uplink, at UE 1204, a transmit processor 1364 may receive and process data from a data source 1362 and control information (e.g., for reports comprising RSRP, RSSI, RSRQ, CQI, and/or the like) from controller/processor 1380. Transmit processor 1364 may also generate reference symbols for one or more reference signals (e.g., based at least in part on a beta value or a set of beta values associated with the one or more reference signals). The symbols from transmit processor 1364 may be precoded by a TX-MIMO processor 1366 if application, further processed by modulators 1354a through 1354r (e.g., for DFT-s-OFDM, CP-OFDM, and/or the like), and transmitted to base station 1202. At base station 1202, the uplink signals from UE 1204 and other UEs may be received by antennas 1334a through 1334t, processed by demodulators 1332a through 1332t, detected by a MIMO detector 1336 if applicable, and further processed by a receive processor 1338 to obtain decoded data and control information sent by UE 1204. Receive processor 1338 may provide the decoded data to a data sink 1339 and the decoded control information to controller (processor) 1340. Base station 1202 may include communication unit 1344 and communicate to a network controller 1331 via communication unit 1344. Network controller 1331 may include communication unit 1394, controller/processor 1390, and memory 1392.

In some aspects, one or more components of UE 1204 may be included in a housing. Controller 1340 of base station 1202, controller/processor 1380 of UE 1204, and/or any other component(s) of FIG. 13 may perform one or more techniques associated with providing a phase continuity configuration in CLI-based sensing.

Memories 1342 and 1382 may store data and program codes for the base station 1202 and the UE 1204, respectively. A scheduler 246 may schedule UEs for data transmission on the downlink, uplink, and/or sidelink.

In some implementations, the UE 1204 can include: means for receiving a first signal based on a reflection of a second signal from a target, wherein the first signal comprises a waveform including a plurality of communications instances and a plurality of sensing instances; and means for determining, using radio frequency sensing, at least one characteristic of the target based on information in at least one of the plurality of sensing instances. In some examples, the means for receiving can include controller/processor 1380, transmit processor 1364, TX MIMO processor 1366, DEMODs 1354a through 1354r, antennas 1352a through 1352r, any combination thereof, or any other component(s) of the UE 1204. In some examples, the means for determining can include controller/processor 1380, memory 1382, receive processor 1358, transmit processor 1364, any combination thereof, or any other component(s) of the UE 1204.

In some implementations, the base station 1202 can include: means for receiving a first signal based on a reflection of a second signal from a target, wherein the first signal comprises a waveform including a plurality of communications instances and a plurality of sensing instances; and means for determining, using radio frequency sensing, at least one characteristic of the target based on information in at least one of the plurality of sensing instances. In some examples, the means for receiving can include controller/processor 1340, transmit processor 1320, TX MIMO processor 1330, MODs 1332a through 13321, antennas 1334a through 1334t, any combination thereof, or any other component(s) of the base station 1202. In some examples, the means for determining can include controller/processor 1340, memory 1342, receive processor 1338, transmit processor 1320, any combination thereof, or any other component(s) of the base station 1202.

FIG. 14 is a diagram illustrating an example of a disaggregated base station 1400 architecture, which may be employed by the disclosed systems and techniques for a phase continuity configuration in CLI-based sensing, in accordance with some examples. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB. AP, a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

As previously mentioned, FIG. 14 shows a diagram illustrating an example disaggregated base station 1400 architecture. The disaggregated base station 1400 architecture may include one or more central units (CUs) 1410 that can communicate directly with a core network 1420 via a backhaul link, or indirectly with the core network 1420 through one or more disaggregated base station units (such as a Near-Real Time (Near-RT) RAN Intelligent Controller (RIC) 1425 via an E2 link, or a Non-Real Time (Non-RT) RIC 1415 associated with a Service Management and Orchestration (SMO) Framework 1405, or both). A CU 1410 may communicate with one or more distributed units (DUs) 1430 via respective midhaul links, such as an FI interface. The DUs 1430 may communicate with one or more radio units (RUs) 1440 via respective fronthaul links. The RUs 1440 may communicate with respective UEs 1420 via one or more RF access links. In some implementations, the UE 1420 may be simultaneously served by multiple RUs 1440.

Each of the units, i.e., the CUS 1410, the DUs 1430, the RUs 1440, as well as the Near-RT RICs 1425, the Non-RT RICs 1415 and the SMO Framework 1405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 1410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 1410. The CU 1410 may be configured to handle user plane functionality (i.e., Central Unit-User Plane (CU-UP)), control plane functionality (i.e., Central Unit-Control Plane (CU-CP)), or a combination thereof. In some implementations, the CU 1410 can be logically split into one or more CU-UP units and one or more CU-CP units. The CU-UP unit can communicate bidirectionally with the CU-CP unit via an interface, such as the E1 interface when implemented in an O-RAN configuration. The CU 1410 can be implemented to communicate with the DU 1430, as necessary, for network control and signaling.

The DU 1430 may correspond to a logical unit that includes one or more base station functions to control the operation of one or more RUs 1440. In some aspects, the DU 1430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 1430 may further host one or more low PHY layers. Each layer (or module) can be implemented with an interface configured to communicate signals with other layers (and modules) hosted by the DU 1430, or with the control functions hosted by the CU 1410.

Lower-layer functionality can be implemented by one or more RUs 1440. In some deployments, an RU 1440, controlled by a DU 1430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 1440 can be implemented to handle over the air (OTA) communication with one or more UEs 1420. In some implementations, real-time and non-real-time aspects of control and user plane communication with the RU(s) 1440 can be controlled by the corresponding DU 1430. In some scenarios, this configuration can enable the DU(s) 1430 and the CU 1410 to be implemented in a cloud-based RAN architecture, such as a vRAN architecture.

The SMO Framework 1405 may be configured to support RAN deployment and provisioning of non-virtualized and virtualized network elements. For non-virtualized network elements, the SMO Framework 1405 may be configured to support the deployment of dedicated physical resources for RAN coverage requirements which may be managed via an operations and maintenance interface (such as an O1 interface). For virtualized network elements, the SMO Framework 1405 may be configured to interact with a cloud computing platform (such as an open cloud (O-Cloud) 1490) to perform network element life cycle management (such as to instantiate virtualized network elements) via a cloud computing platform interface (such as an O2 interface). Such virtualized network elements can include, but are not limited to, CUs 1410, DUs 1430, RUs 1440 and Near-RT RICs 1425. In some implementations, the SMO Framework 1405 can communicate with a hardware aspect of a 4G RAN, such as an open eNB (O-eNB) 1411, via an O1 interface. Additionally, in some implementations, the SMO Framework 1405 can communicate directly with one or more RUs 1440 via an O1 interface. The SMO Framework 1405 also may include a Non-RT RIC 1415 configured to support functionality of the SMO Framework 1405.

The Non-RT RIC 1415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 1425. The Non-RT RIC 1415 may be coupled to or communicate with (such as via an A1 interface) the Near-RT RIC 1425. The Near-RT RIC 1425 may be configured to include a logical function that enables near-real-time control and optimization of RAN elements and resources via data collection and actions over an interface (such as via an E2 interface) connecting one or more CUs 1410, one or more DUs 1430, or both, as well as an O-eNB, with the Near-RT RIC 1425.

In some implementations, to generate AI/ML models to be deployed in the Near-RT RIC 1425, the Non-RT RIC 1415 may receive parameters or external enrichment information from external servers. Such information may be utilized by the Near-RT RIC 1425 and may be received at the SMO Framework 1405 or the Non-RT RIC 1415 from non-network data sources or from network functions. In some examples, the Non-RT RIC 1415 or the Near-RT RIC 1425 may be configured to tune RAN behavior or performance. For example, the Non-RT RIC 1415 may monitor long-term trends and patterns for performance and employ AI/ML models to perform corrective actions through the SMO Framework 1405 (such as reconfiguration via 01) or via creation of RAN management policies (such as A1 policies).

FIG. 15 is a block diagram illustrating an example of a computing system 1500 that may be employed by the disclosed system for joint communications and RF sensing, in accordance with some examples. In particular, FIG. 15 illustrates an example of computing system 1500, which can be for example any computing device making up internal computing system, a remote computing system, a camera, or any component thereof in which the components of the system are in communication with each other using connection 1505. Connection 1505 can be a physical connection using a bus, or a direct connection into processor 1510, such as in a chipset architecture. Connection 1505 can also be a virtual connection, networked connection, or logical connection.

In some aspects, computing system 1500 is a distributed system in which the functions described in this disclosure can be distributed within a datacenter, multiple data centers, a peer network, etc. In some cases, one or more of the described system components represents many such components each performing some or all of the function for which the component is described. In some aspects, the components can be physical or virtual devices.

Example system 1500 includes at least one processing unit (CPU or processor) 1510 and connection 1505 that communicatively couples various system components including system memory 1515, such as read-only memory (ROM) 1520 and random access memory (RAM) 1525 to processor 1510. Computing system 1500 can include a cache 1512 of high-speed memory connected directly with, in close proximity to, or integrated as part of processor 1510.

Processor 1510 can include any general purpose processor and a hardware service or software service, such as services 1532, 1534, and 1536 stored in storage device 1530, configured to control processor 1510 as well as a special-purpose processor where software instructions are incorporated into the actual processor design. Processor 1510 may essentially be a completely self-contained computing system, containing multiple cores or processors, a bus, memory controller, cache, etc. A multi-core processor may be symmetric or asymmetric.

To enable user interaction, computing system 1500 includes an input device 1545, which can represent any number of input mechanisms, such as a microphone for speech, a touch-sensitive screen for gesture or graphical input, keyboard, mouse, motion input, speech, etc. Computing system 1500 can also include output device 1535, which can be one or more of a number of output mechanisms. In some instances, multimodal systems can enable a user to provide multiple types of input/output to communicate with computing system 1500.

Computing system 1500 can include communications interface 1540, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1540 may also include one or more range sensors (e.g., light detection and ranging (LIDAR) sensors, laser range finders, RF radars, ultrasonic sensors, and infrared (IR) sensors) configured to collect data and provide measurements to processor 1510, whereby processor 1510 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1540 may also include one or more Global Navigation Satellite System (GNSS) receivers or transceivers that are used to determine a location of the computing system 1500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1530 can include software services, servers, services, etc., that when the code that defines such software is executed by the processor 1510, it causes the system to perform a function. In some aspects, a hardware service that performs a particular function can include the software component stored in a computer-readable medium in connection with the necessary hardware components, such as processor 1510, connection 1505, output device 1535, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor.” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative aspects of the disclosure include:

Aspect 1: A method for communications and sensing, the method comprising: receiving, by a receiver, a first signal based on a reflection of a second signal from a target, wherein the first signal comprises a waveform including a plurality of communications instances and a plurality of sensing instances; and determining, using radio frequency sensing, at least one characteristic of the target based on information in at least one of the plurality of sensing instances.

Aspect 2: The method of Aspect 1, wherein the at least one characteristic comprises at least one of a range, a doppler frequency, or an angle associated with the target.

Aspect 3: The method of any of Aspects 1 to 2, wherein the waveform is an orthogonal frequency-division multiplexing (OFDM) waveform.

Aspect 4: The method of any of Aspects 1 to 3, wherein each communications instance of the plurality of communications instances comprises a communications symbol.

Aspect 5: The method of any of Aspects 1 to 4, wherein each sensing instance of the plurality of sensing instances comprises a plurality of radar reference signals.

Aspect 6: The method of Aspect 5, wherein the at least one characteristic of the target is determined based on at least one radar reference signal of the plurality of radar reference signals.

Aspect 7: The method of any of Aspects 5 or 6, wherein the plurality of radar reference signals are continuous within each sensing instance of the plurality of sensing instances.

Aspect 8: The method of any of Aspects 5 or 6, wherein the plurality of radar reference signals are not continuous within each sensing instance of the plurality of sensing instances.

Aspect 9: The method of any of Aspects 1 to 8, wherein each sensing instance of the plurality of sensing instances comprises a single radar reference signal.

Aspect 10: The method of any of Aspects 1 to 9, wherein the radio frequency sensing is monostatic sensing, and wherein the receiver is co-located with a transmitter transmitting the second signal.

Aspect 11: The method of any of Aspects 1 to 10, wherein the radio frequency sensing is bistatic sensing, and wherein the receiver is located remotely from a transmitter transmitting the second signal.

Aspect 12: An apparatus for communications and sensing, comprising: a memory; and one or more processors coupled to the memory, the one or more processors configured to: receive a first signal based on a reflection of a second signal from a target, wherein the first signal comprises a waveform including a plurality of communications instances and a plurality of sensing instances; and determine, using radio frequency sensing, at least one characteristic of the target based on information in at least one of the plurality of sensing instances.

Aspect 13: The apparatus of Aspect 12, wherein the at least one characteristic comprises at least one of a range, a doppler frequency, or an angle associated with the target.

Aspect 14: The apparatus of any of Aspects 12 to 13, wherein the waveform is an orthogonal frequency-division multiplexing (OFDM) waveform.

Aspect 15: The apparatus of any of Aspects 12 to 14, wherein each communications instance of the plurality of communications instances comprises a communications symbol.

Aspect 16: The apparatus of any of Aspects 12 to 15, wherein each sensing instance of the plurality of sensing instances comprises a plurality of radar reference signals.

Aspect 17: The apparatus of Aspect 16, wherein the at least one characteristic of the target is determined based on at least one radar reference signal of the plurality of radar reference signals.

Aspect 18: The apparatus of any of Aspects 16 or 17, wherein the plurality of radar reference signals are continuous within each sensing instance of the plurality of sensing instances.

Aspect 19: The apparatus of any of Aspects 16 or 17, wherein the plurality of radar reference signals are not continuous within each sensing instance of the plurality of sensing instances.

Aspect 20: The apparatus of any of Aspects 12 to 19, wherein each sensing instance of the plurality of sensing instances comprises a single radar reference signal.

Aspect 21: The apparatus of any of Aspects 12 to 20, wherein the radio frequency sensing is monostatic sensing, and wherein a receiver of the apparatus is co-located with a transmitter of the apparatus transmitting the second signal.

Aspect 22: The apparatus of any of Aspects 12 to 21, wherein the radio frequency sensing is bistatic sensing, and wherein a receiver of the apparatus is located remotely from a transmitter transmitting the second signal.

Aspect 23: A non-transitory computer-readable medium of a receiver, the non-transitory computer-readable medium having stored thereon instructions that, when executed by one or more processors, cause the one or more processors to: receive a first signal based on a reflection of a second signal from a target, wherein the first signal comprises a waveform including a plurality of communications instances and a plurality of sensing instances; and determine, using radio frequency sensing, at least one characteristic of the target based on information in at least one of the plurality of sensing instances.

Aspect 24: A non-transitory computer-readable medium of a receiver, the non-transitory computer-readable medium having stored thereon instructions that, when executed by one or more processors, cause the one or more processors to perform operations according to any of Aspects 1 to 22.

Aspect 25: An apparatus for communications and sensing, comprising: means for receiving a first signal based on a reflection of a second signal from a target, wherein the first signal comprises a waveform including a plurality of communications instances and a plurality of sensing instances; and means for determining, using radio frequency sensing, at least one characteristic of the target based on information in at least one of the plurality of sensing instances.

Aspect 26: An apparatus for communications and sensing, comprising one or more means for performing operations according to any of Aspects 1 to 22.

What is claimed is:

1. A method for communications and sensing, the method comprising:
receiving, by a receiver, a first signal based on a reflection of a second signal from a target, wherein the first signal comprises a waveform including a plurality of communications instances and a plurality of sensing instances; and
determining, using radio frequency sensing, at least one characteristic of the target based on information in at least one of the plurality of sensing instances.

2. The method of claim 1, wherein the at least one characteristic comprises at least one of a range, a doppler frequency, or an angle associated with the target.

3. The method of claim 1, wherein the waveform is an orthogonal frequency-division multiplexing (OFDM) waveform.

4. The method of claim 1, wherein each communications instance of the plurality of communications instances comprises a communications symbol.

5. The method of claim 1, wherein each sensing instance of the plurality of sensing instances comprises a plurality of radar reference signals.

6. The method of claim 5, wherein the at least one characteristic of the target is determined based on at least one radar reference signal of the plurality of radar reference signals.

7. The method of claim 5, wherein the plurality of radar reference signals are continuous within each sensing instance of the plurality of sensing instances.

8. The method of claim 5, wherein the plurality of radar reference signals are not continuous within each sensing instance of the plurality of sensing instances.

9. The method of claim 1, wherein each sensing instance of the plurality of sensing instances comprises a single radar reference signal.

10. The method of claim 1, wherein the radio frequency sensing is monostatic sensing, and wherein the receiver is co-located with a transmitter transmitting the second signal.

11. The method of claim 1, wherein the radio frequency sensing is bistatic sensing, and wherein the receiver is located remotely from a transmitter transmitting the second signal.

12. An apparatus for communications and sensing, comprising:
a memory; and
one or more processors coupled to the memory, the one or more processors configured to:
receive a first signal based on a reflection of a second signal from a target, wherein the first signal comprises a waveform including a plurality of communications instances and a plurality of sensing instances, and
determine, using radio frequency sensing, at least one characteristic of the target based on information in at least one of the plurality of sensing instances.

13. The apparatus of claim 12, wherein the at least one characteristic comprises at least one of a range, a doppler frequency, or an angle associated with the target.

14. The apparatus of claim 12, wherein the waveform is an orthogonal frequency-division multiplexing (OFDM) waveform.

15. The apparatus of claim 12, wherein each communications instance of the plurality of communications instances comprises a communications symbol.

16. The apparatus of claim 12, wherein each sensing instance of the plurality of sensing instances comprises a plurality of radar reference signals.

17. The apparatus of claim 16, wherein the at least one characteristic of the target is determined based on at least one radar reference signal of the plurality of radar reference signals.

18. The apparatus of claim 16, wherein the plurality of radar reference signals are continuous within each sensing instance of the plurality of sensing instances.

19. The apparatus of claim 16, wherein the plurality of radar reference signals are not continuous within each sensing instance of the plurality of sensing instances.

20. The apparatus of claim 12, wherein each sensing instance of the plurality of sensing instances comprises a single radar reference signal.

21. The apparatus of claim 12, wherein the radio frequency sensing is monostatic sensing, and wherein a receiver of the apparatus is co-located with a transmitter of the apparatus transmitting the second signal.

22. The apparatus of claim 12, wherein the radio frequency sensing is bistatic sensing, and wherein a receiver of the apparatus is located remotely from a transmitter transmitting the second signal.

23. A non-transitory computer-readable medium of a receiver, the non-transitory computer-readable medium having stored thereon instructions that, when executed by one or more processors, cause the one or more processors to:
receive a first signal based on a reflection of a second signal from a target, wherein the first signal comprises a waveform including a plurality of communications instances and a plurality of sensing instances; and
determine, using radio frequency sensing, at least one characteristic of the target based on information in at least one of the plurality of sensing instances.

24. The computer-readable medium of claim 23, wherein the at least one characteristic comprises at least one of a range, a doppler frequency, or an angle associated with the target.

25. The computer-readable medium of claim 23, wherein the waveform is an orthogonal frequency-division multiplexing (OFDM) waveform.

26. The computer-readable medium of claim 23, wherein each communications instance of the plurality of communications instances comprises a communications symbol.

27. The computer-readable medium of claim 23, wherein each sensing instance of the plurality of sensing instances comprises a plurality of radar reference signals.

28. The computer-readable medium of claim 27, wherein the at least one characteristic of the target is determined based on at least one radar reference signal of the plurality of radar reference signals.

29. The computer-readable medium of claim 27, wherein the plurality of radar reference signals are continuous within each sensing instance of the plurality of sensing instances.

30. The computer-readable medium of claim 27, wherein the plurality of radar reference signals are not continuous within each sensing instance of the plurality of sensing instances.
